(19) United States
(12) Patent Application Publication
(10) Pub. No.: US 2002/0133486 A1
(43) Pub. Date: Sep. 19, 2002

(54) Video retrieval and browsing apparatus, video retrieval, browsing and editing apparatus, and recording medium

(75) Inventors: Hiromasa Yanagihara, Saitama (JP); Yasuyuki Nakajima, Saitama (JP); Masaru Sugano, Saitama (JP)

Correspondence Address: ARMSTRONG,WESTERMAN & HATTORI, LLP, 1725 K STREET, NW., SUITE 1000, WASHINGTON, DC, 20006, US

(73) Assignee: KDDI CORPORATION, Tokyo (JP)

(21) Appl. No.: 10/095,967

(22) Filed: Mar. 13, 2002

(30) Foreign Application Priority Data
Mar. 15, 2001 (JP) 2001-74185
Mar. 15, 2001 (JP) 2001-74186

(51) Int. Cl. G06F 7/00

(52) U.S. Cl. 707/3

(57) ABSTRACT

A thumbnail data having a time necessary for browsing display is extracted from a video file stored in a storage device in real time using query (cut point query, query by telop such as news, audio classification data, etc.), and then, high-precise thumbnail retrieval and browsing is carried out at frame unit and second unit. Further, high-precise segment playback by designating the thumbnail retrieval and browsing time as playback start/end points can be achieved without preparing a thumbnail data saving storage device. Therefore, it is possible to achieve high-precise thumbnail retrieval and browsing at frame unit and second unit without previously preparing and saving the thumbnail data. Further, it is possible to provide a retrieval, browsing and editing apparatus, which can effectively and accurately realize frame unit edit processing using the thumbnail retrieval and browsing, and to provide a recording medium recording the processing program.

### BACKGROUND OF THE INVENTION

1. Field of the Invention

The present invention relates to a retrieval and browsing apparatus for digital video contents such as MPEG, to a video retrieval, browsing and editing apparatus, which can effectively and precisely carry out edition processing of frame unit using thumbnail retrieval and browsing result, and to a recording medium storing programs used for them.

2. Description of the Related Art

The first conventional example, that is, a local type video retrieval and browsing apparatus will be described below with reference to FIG. 43. In FIG. 43, a video content storage device 502 is previously stored with video contents. A query storage device 501 previously detects and saves queries or retrieval data such as cut points from the stored video by using any methods or means. Further, the query storage device 501 previously extracts and saves a browsing thumbnail still image such as JPEG file corresponding to a time code such as the cut point by using any methods or means.

In the case of retrieving the video contents, a retrieval and playback command input section 507 designates a video file name, and then, a retrieval start command is inputted to a controller 504. Whereupon the controller 504 outputs a retrieval start time code and data on the number of retrievals of browsing thumbnail to a retrieval section 503. The retrieval section 503 fetches the corresponding thumbnail sequence from the query storage device 501 based on the input data, and then, browse-displays it on a search result browser 506 via the controller 504.

Regarding video playback, for example, a user instructs time codes desired to start and end the video playback on a browsing display of the search result browser 506. Whereupon a playback command is inputted to the controller 504 via the retrieval and playback command input section 507 together with the playback start and end time codes and the video file name. Subsequently, these data is transmitted to a video playback section 505. The video playback section 505 extracts a designated segment data of video contents designated by the video content storage device 502, and then, transmits it to a video display 508. Thereafter, the video display 508 carries out segment playback from the playback start point to the playback end point.

Next, the second conventional example, that is, a server client type video retrieval and browsing apparatus will be detailedly described below with reference to FIG. 44. The video contents stored in a video content storage device 512 and the query such as video cut point saved in a query storage device 511 are the same as the case of FIG. 43.

In the case of retrieving the video contents, a retrieval and playback command input section 519 on the client side designates a video file name, and then, a retrieval start command is inputted to a controller 514 via a network 517 and a WWW server 516. Whereupon a retrieval start time code and the number of retrievals of browsing thumbnail are outputted to a retrieval section 513. The retrieval section 513 fetches the corresponding thumbnail sequence from the query storage device 511 based on the input data, and then, transmits it to a search result browser 518 via the controller 514, WWW server 516 and network 517. The thumbnail sequence is browse-displayed on the search result browser 518.

Regarding video playback, for example, a user instructs time codes desired to start and end the video playback on a browsing display of the search result browser 518. Whereupon a playback command is transferred to a video server 515 from a retrieval and playback command input section 519 via the network 517 together with the playback start and end time codes and the video file name. Subsequently, the video server 515 extracts a designated segment data of designated video contents from the video content storage device 512, and then, transmits it to a video display 520 via the network 517. As a result, segment playback from the playback start point to the playback end point of the designated video content is carried out.

In the above first and second conventional examples, only specified thumbnail data is previously generated from the video query such as cut point. For this reason, it has been difficult to carry out thumbnail retrieval and browsing of frame unit or second unit, and segment playback by designating the time as playback start point and end point.

In order to solve the above problem, a method of previously generating thumbnails corresponding to all frames has been proposed. In this case, however, the total quantity of thumbnail data becomes larger than a quantity of data of the original video. As a result, the following problem arises; more specifically, two times or more storage capacity is required as compared with the case of storing only video data, and processing time for extracting the whole thumbnails is required.

Further, in the above first and second conventional examples, the cut point query has been used as query used for thumbnail retrieval and browsing. In this case, however, it is difficult to carry out thumbnail retrieval and browsing using query of a telop such as news, or audio classification data and segment playback designating the playback start point and the playback end point.

Next, the following is a description on a conventional video retrieval, browsing and editing apparatus. In retrieval, browsing and editing apparatus of the initial digital video contents, a digital video data stored in hard disk is fast-forwarded and rewound using a random access function of the hard disk, thereby, the edit point is designated, and thus, an edit work has been done. In this case, however, a great large of time has been spent in the case of editing long-time retrieval contents.

For example, in “the video retrieval and editing apparatus disclosed in Japanese Patent Application Laid-Open No. 10-66008” proposed by the present applicant, macro retrieval by cut point data and frame unit micro retrieval are combined, and thereby, it is possible to greatly shorten the time to designate the edit point.

However, it is impossible to precisely detect a telop appearing frame characterizing a semantic switchover in scenes such as news video, and a point switching from human's voice to BGM. Further, there are many cases where much time and labor are inevitably taken to determine fine edit points depending on the video contents.

In the case of editing digital video contents of MPEG format on compressed data, it is possible to edit the digital video contents at a GOP (Group of Picture) unit; however, in the case of editing the contents at frame precision, all of frames are temporarily decoded, and thereafter, edit and re-compression must be carried out. In this case, a temporal saving disk for decoding is required, and a degradation of picture quality is generated by decoding and re-coding, and in addition, there is a possibility such that the editing process must be made for a long time.

In the case of inspecting the video data after being edited, in order to check subtle connection between image and voice on the joint portion, that is, edit points, all editing must be once completed. If a fail exists in the above editing, the following work must be repeatedly done; more specifically, the edit point is finely adjusted, and editing is again carried out, and then confirmation whether the fail is corrected is carried out.

Further, in the case where the user desires to retry the editing work once completed from the completed point of time, or in the case where the user desires to do a mutual editing work with another editing system, designation of video contents and preparation of each edit point list must be again carried out by manual.

### SUMMARY OF THE INVENTION

The present invention has been made in view of the above problems. Accordingly, an object of the present invention is to provide a video retrieval and browsing apparatus, which can extract thumbnail data having a time necessary for browse-display from video files stored in a storage device using query in real time, and make without using a storage device for saving thumbnail data.

Further, another object of the present invention is to provide a video retrieval and browsing apparatus, which can perform thumbnail retrieval and browsing using query by telop such as news and audio classification data other than cut point query as query used for thumbnail retrieval and browsing and segment playback by designating playback start point and end point.

Further, another object of the present invention is to provide a recording medium recording a program for extracting thumbnail in real time.

Further, another object of the present invention is to provide a recording medium recording a retrieval and browsing control program for achieving retrieval and browsing complexly using cut point query, query by telop or query by audio classification.

Further, another object of the present invention is to provide a retrieval, browsing and editing apparatus, which can complexly carry out cut point retrieval, telop retrieval, audio classification or frame unit retrieval from video files stored in a storage device, and can effectively and precisely achieve frame unit editing using the thumbnail retrieval and browsing result.

Further, another object of the present invention is to provide a recording medium recording an editing processing program capable of achieving prevention of degradation of picture quality, temporary saving disk reduction by non-execution of the entire decoding, and high-speed processing by carrying out frame precision editing on MPEG compressed data in an editing process.

Further, another object of the present invention is to provide a recording medium recording a splice edit playback processing program for confirming visual consistency of a joint portion between edit points before execution of edit.

Further, another object of the present invention is to provide a retrieval, browsing and editing apparatus and a recording medium recording a processing program, which can input and output an edit segment list as EDL (Edit Decision List) conformable to SMPTE (Society of Motion Picture & Television engineers) in video editing, and thereby, can restart a previously completed edit work from the completed point of time, and perform mutual edit work with an external system.

In order to achieve the above described object, a first characteristic of present invention is that a video retrieval and browsing apparatus for retrieving and browsing a digital video content such as MPEG, comprising: time direction retrieval means for carrying out time direction retrieval of video content; thumbnail extracting means for extracting a thumbnail from the video content in real time based on the retrieval result of the time direction retrieval means; and search result browser for browse-displaying the retrieval result using the thumbnail extracted by the thumbnail extracting means. According to this characteristic, it is possible to realize thumbnail retrieval and browsing without previously preparing and saving thumbnail data. Further, it is possible to realize high-precise thumbnail retrieval and browsing at frame unit and second unit.

A second characteristic of present invention is that the video content is stored in a WWW server, and the time direction retrieval means and the thumbnail extracting means is provided in the WWW server. A third characteristic of present invention is that a WWW browser is connected to the WWW server via a network so that the WWW server can carry out video retrieval processing, and the WWW browser can designate retrieval conditions and browse-display the retrieval result. According to these characteristics, a thumbnail retrieval and editing processing is not only carried out on the local host computer, but also is carried out on the network in a state of having video data in common.

A fourth characteristic of present invention resides in a computer readable recording medium recording a thumbnail extracting processing program for extracting a thumbnail from a video content in real time based on the given time code sequence. According to this characteristic, the program recorded in the recording medium is read into the computer, and thereby, the present invention can be realized on computers such as personal computers.

A fifth characteristic of present invention is that a video retrieval, browsing and editing apparatus for editing a digital video content such as MPEG, comprises means for designating an edit start point and an edit end point using thumbnail retrieval and browsing result complexly using cut point retrieval, telop retrieval, audio classification and frame unit retrieval. According to this characteristic, it is possible to effectively and accurately designate the edit start/end points using the cut point retrieval, the telop retrieval, the audio classification and the frame unit retrieval, and thereby, to achieve video frame unit edit.

A sixth characteristic of present invention is that the video retrieval, browsing and editing apparatus includes means for decoding only partial data before and after the edit point to base band, and editing and re-compressing it in the case of carrying out the frame unit edit processing of MPEG content in a state that the data other than the partial data before and after the edit point is intactly compressed data. According to this characteristic, it is possible to prevent degradation of picture quality, to reduce a temporary saving disk by non-execution of the entire decoding, and to realize high-speed processing, because only partial data before and after the edit point is decoded to base band and then is re-compressed.

Farther, a seventh characteristic of present invention resides in a computer readable recording medium recording a program for decoding only partial data before and after the edit point designated using the thumbnail retrieval and browsing result to base band, editing it at the edit point, and re-compressing the decoded data in the case of carrying out the frame unit edit processing of MPEG content. According to this characteristic, it is possible to provide a computer readable recording medium recording the program capable of preventing degradation of picture quality by non-execution of the entire decoding of MPEG content, reducing a temporary saving disk, and realizing high-speed processing.

### BRIEF DESCRIPTION OF THE DRAWINGS

FIG. 1 is a block diagram schematically showing a configuration of video retrieval and browsing apparatus (local type) according to a first embodiment of the present invention;

FIG. 2 is a view to explain a cut point query description;

FIG. 3 is a block diagram to explain a function of thumbnail extracting section;

FIG. 4 is a view to explain an MPEG frame structure;

FIG. 5 is a view to explain a thumbnail extracting operation;

FIG. 6 is a view showing an example of a cut point retrieval and browsing display;

FIG. 7 is a view showing an example of a frame unit retrieval and browsing display;

FIG. 8 is a view showing a relation between cut point time codes and frame unit time codes;

FIG. 9 is a view showing a video index browser and video player of the first embodiment;

FIG. 10 is a block diagram schematically showing a configuration of video retrieval and browsing apparatus (local type) according to a second embodiment of the present invention;

FIG. 11 is a view to explain a telop query description;

FIG. 12 is a view showing a telop retrieval and browsing display;

FIG. 13 is a view showing a relation between telop start point time codes and frame unit time codes;

FIG. 14 is a view showing an example of a video index browser and video player of the second embodiment;

FIG. 15 is a block diagram schematically showing a configuration of video retrieval and browsing apparatus (local type) according to a third embodiment of the present invention;

FIG. 16 is a view to explain an audio classification data description;

FIG. 17 is a view showing an example of an audio classification retrieval and browsing display;

FIG. 18 is a view showing a relation between audio classification point time codes and frame unit time codes;

FIG. 19 is a view showing an example of a video index browser and video player of the third embodiment;

FIG. 20 is a block diagram schematically showing a configuration of video retrieval and browsing apparatus (local type) according to a fourth embodiment of the present invention;

FIG. 21 is a view showing an example of a combined display of a cut point browser and an audio classification browser;

FIG. 22 is a view showing an example of a video index browser and video player of the fourth embodiment;

FIG. 23 is a view schematically showing a configuration of video retrieval and browsing apparatus (local type) according to a fifth embodiment of the present invention;

FIG. 24 is a view showing an example of a combined display of a telop retrieval browser and an audio classification browser;

FIG. 25 is a view showing an example of a video index browser and video player of the fifth embodiment;

FIG. 26 is a block diagram schematically showing a configuration of video retrieval and browsing apparatus (local type) according to a sixth embodiment of the present invention;

FIG. 27 is a view showing an example of a video index browser and video player of the fifth embodiment;

FIG. 28 is a block diagram schematically showing a configuration of video retrieval and browsing apparatus (server client type) according to a seventh embodiment of the present invention;

FIG. 29 is a block diagram schematically showing a configuration of video retrieval and browsing apparatus (local type) according to an eighth embodiment of the present invention;

FIG. 30 is a view to explain frame unit edit on compressed data of MPEG contents;

FIG. 31 is a view showing a relation between a stream picture order and a display picture order in MPEG;

FIG. 32 is a view to explain frame unit edit on MPEG compression;

FIG. 33 is a view to explain frame unit edit (the edit point former half) on MPEG compression;

FIG. 34A and FIG. 34B are views to explain another frame unit edit (the edit point former half) on MPEG compression;

FIG. 35A and FIG. 35B are views to explain another frame unit edit (the edit point former half) on MPEG compression;

FIG. 36 is a view to explain frame unit edit (the edit point latter half) on MPEG compression;

FIG. 37A and FIG. 38B are views to explain another frame unit edit (the edit point latter half) on MPEG compression;

FIG. 38A and FIG. 38B are views to explain another frame unit edit (the edit point latter half) on MPEG compression;

FIG. 39 is a view showing an example of an edit control display screen of the eighth embodiment;

FIG. 40 is a view to explain editing by EDL files;

FIG. 41 is a block diagram schematically showing a configuration of video retrieval and browsing apparatus (server client type) according to a ninth embodiment of the present invention;

FIG. 42 is a block diagram showing a configuration of program readable computer of the present invention;

FIG. 43 is a block diagram showing a configuration of conventional video retrieval and browsing apparatus (local type); and

FIG. 44 is a block diagram showing a configuration of another conventional video retrieval and browsing apparatus (server client type).

### DETAILED DESCRIPTION OF THE PREFERRED EMBODIMENTS

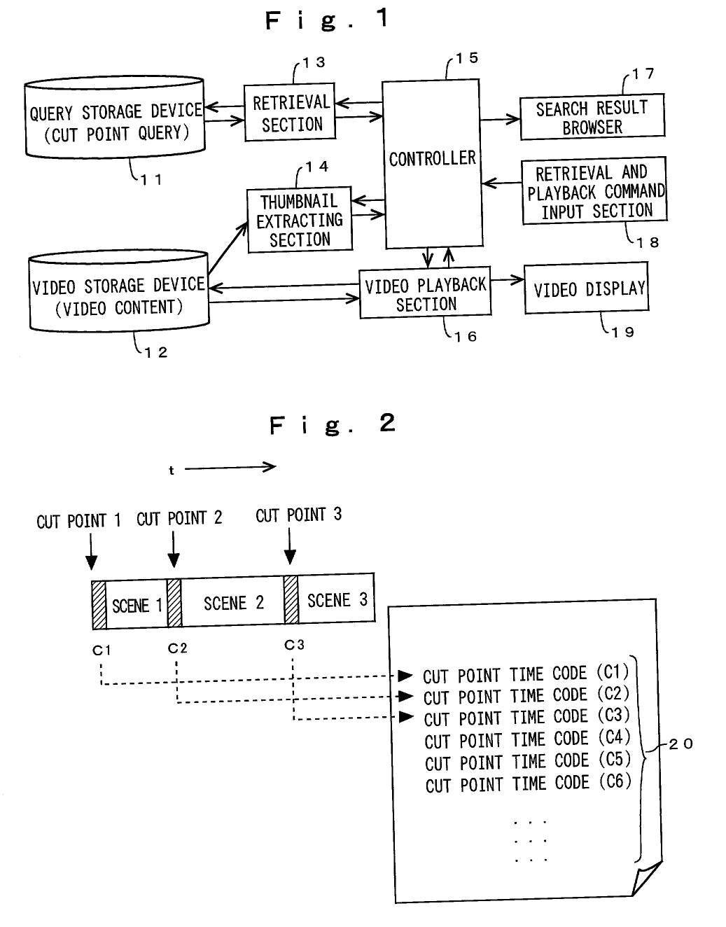

The present invention will be described below in detail with reference to the accompanying drawings. First, a first embodiment of the present invention, that is, a local type video retrieval and browsing apparatus will be described with reference to a block diagram shown in FIG. 1.

[First Embodiment]

According to this first embodiment, thumbnail is extracted in real time from a video using cut point query or frame unit and second unit time code sequence, and thereby, it is possible to carry out high precision thumbnail retrieval and browsing at frame unit and second unit. Further, the time is designated as playback start/end point, and thereby, it is possible to carry out high precision segment playback on local host computer without using an additional storage device for saving the entire thumbnail data.

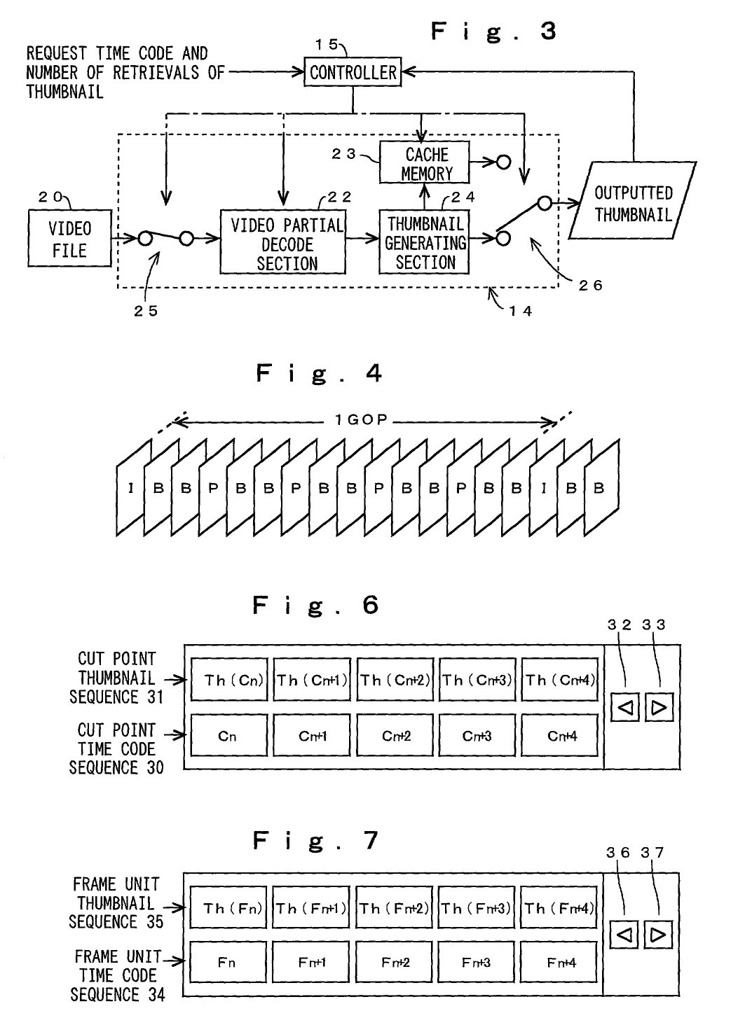

In FIG. 1, a video storage device 12 is previously stored with video contents. A cut point query showing a break of scene is previously detected from the video contents stored in the video storage device 12, and thereafter, it is saved in a query storage device 11. The cut point query is composed of a cut point browsing time code sequence 20, as described later with reference to FIG. 2. In this first embodiment, the important matters are as follows; more specifically, there is no need of previously extracting browsing thumbnails such as JPEG files corresponding to time codes included in the cut point query from the video contents as done in the conventional retrieval and browsing apparatus, and previously saving them in the query storage device 11.

The method described in “video cut point detecting apparatus disclosed in Japanese Patent Application Laid-Open No. 11-252509” by the present applicant may be employed as the method for retrieving the cut point query. As shown in FIG. 2, a cut point browsing time code sequence (C1, C2, C3, . . . ) 20 is used as the cut point query description. In the cut point browsing time code sequence 20, cut points and detected time codes are arranged in time series order.

When a video file name is designated from a retrieval and playback command input section 18 of FIG. 1, and a cut point retrieval start command is inputted, a controller 15 outputs a cut point start time code and the number of retrievals of a cut point browsing thumbnail to a retrieval section 13. The retrieval section 13 obtains a cut point browsing time code sequence corresponding to the thumbnails to be browsed from the cut point query saved in the query storage device 11 based on the inputted data, and then, outputs it to the controller 15. The controller 15 transfers the obtained cut point browsing time code sequence to a thumbnail extracting section 14, and then, fetches the corresponding thumbnail sequence from the thumbnail extracting section 14, and thereafter, the fetched thumbnail sequence is browse-displayed as the cut point retrieval result on a search result browser 17 via the controller 15.

In the case of retrieving and browsing further detailed contents in a time direction from a cut point position or arbitrary position, the retrieval and playback command input section 18 inputs the following information to the controller 15. More specifically, the information includes time codes of the detailed retrieval and browsing start position, display precision of time directions such as frame unit and second unit, and the number of retrievals of browsing thumbnail. Then, the controller 15 generates a browsing time code sequence having a predetermined time interval from the obtained data, and thereafter, transfers the browsing time code sequence to the thumbnail extracting section 14. Further, the corresponding thumbnail sequence is fetched, and then, is browse-displayed as the retrieval result of predetermined time interval on the search result browser 17 via the controller 15.

In the case of carrying out video segment playback, a video playback start time code and a video playback end time code are commanded on the browse-display of the search result browser 17. Whereupon the retrieval and playback command input section 18 inputs frame precision playback start and end time codes and playback start command data including video file name data to the controller 15. These data is transferred from the controller 15 to the video playback section 16. The video playback section 16 extracts a designated segment data of designated video contents, and thereafter, the video display 19 carries out segment playback from a playback start point to a playback end point. By doing so, frame precision local segment playback is possible.

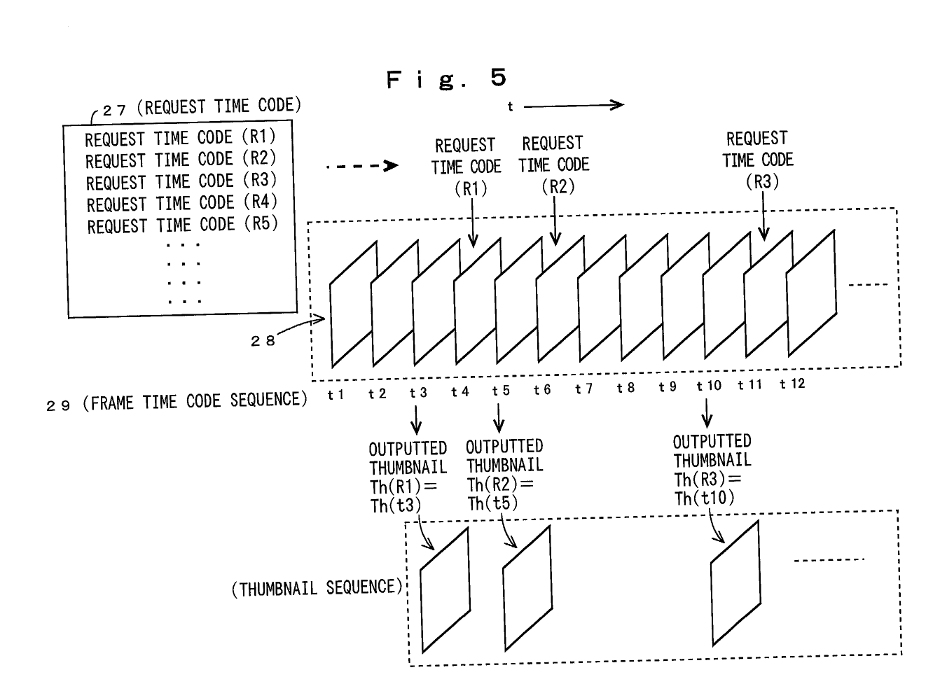

The operation of the thumbnail extracting section 14 will be described in detail with reference to the conceptual views shown in FIG. 3 and FIG. 4. The thumbnail extracting section 14 is composed of a video partial decode section 22, a cache 23 and a thumbnail generating section 24. When a request time code and the number of retrievals of thumbnail are inputted to the controller 15, the controller 15 confirms whether or not the corresponding thumbnail exists in the cache 23, and then, if it exists therein, the cache 23 outputs the corresponding thumbnail via a switch 26. On the other hand, unless the corresponding thumbnails exists therein, data is read from a video file 20 of the video storage device 12 via a switch 25, and then, the video partial decode section 22 partially decodes only necessary frame, and thereafter, the thumbnail generating section 24 generates a thumbnail such as JPEG or the like. The thumbnail thus generated is outputted via the switch 26 while being temporarily saved in the cache 23.

In the case where the video compression format is MPEG, the MPEG frame structure is composed of an intra-frame coding I picture, inter-frame coding P and B pictures, as shown in FIG. 4. Therefore, in the case where a requested time code indicates an inter-frame coding portion, the preceding one or more frame must be decoded. For this reason, there is a possibility such that decoding of the same frame overlaps; as a result, a processing efficiency is reduced. In order to avoid the above disadvantage, a video partial decode minimum unit is set as GOP (Group of Pictures), and all frames of the GOP including the request time code are decoded, and further, a thumbnail having the request time code is outputted while being saved in the cache 23. By doing so, in the case where the next request time code is close to the previous request time code, a probability of secondarily using the cached thumbnail becomes high; therefore, a processing speed can be improved.

Next, mapping between requested time codes, video frame time codes and extracted thumbnail time codes in the thumbnail extracting section 14 will be described in detail with reference to FIG. 5. In a request time code sequence 27 (R1, R2, R3, R4,) having a predetermined time interval such as thumbnail cut point to be browsed or frame unit, a request time code is arranged in the order of time series, and the corresponding adaptable thumbnail sequence (Th(R1), Th(R2), Th(R3), Th(R4),) is extracted from these data.

A thumbnail Th(Rm) corresponding to m request time code Rm [sec] is determined in the following manner; more specifically, tn satisfying the following equation (1) is set as a time fetching the thumbnail corresponding to the m request time code. Namely, in the case of cut point thumbnail extraction, m cut point time code Cm [sec ] is set as request time code Rm [sec], and then, a thumbnail Th(tn) generated from the video frame having tn [sec] time code is used as the output thumbnail Th(Rm) as shown with the following equation (2).

In this case, tn denotes n frame time code of the frame time code sequence (t1, t2, t3, . . . tk) 29 included in a video sequence 28. For example, in the case of NTSC video signal, tn is obtained from the following equation (3).

tn≦Rm<tn+1[sec] (1)

Th(Rm)=Th(tn) (2)

tn=(1/29.97)×n[sec](n=0, 1, 2,) (3)

In the case of extracting a thumbnail from video contents compressed in the format of MPEG, in view of the compression format, the leading frame of GOP (Group of Pictures) including the frame equivalent to the time tn must be decoded so that the corresponding thumbnail can be extracted.

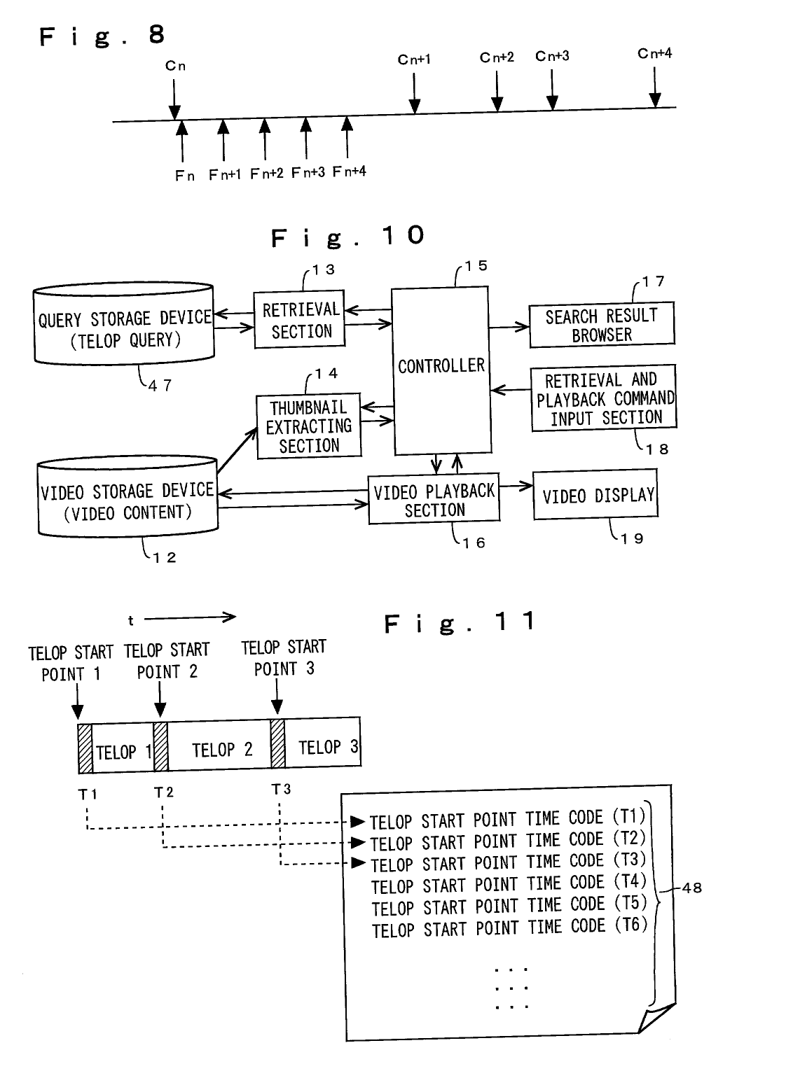

Next, the following is a description on browsing display and playback display of the search result browser 17 (see FIG. 1). FIG. 6 shows a browsing display example of cut point retrieval and browsing. A cut point time code sequence (Cn, Cn+1, Cn+2, Cn+3, Cn+4) 30 is displayed, and simultaneously, a cut point thumbnail sequence (Th(Cn), Th(Cn+1), Th(Cn+2), Th(Cn+3), Th(Cn+4)) is displayed in synchronous with the above display. When pushing a left skip button 32, a cut point time code sequence (Cn−5, Cn−4, Cn−3, Cn−2, Cn−1) and a cut point thumbnail sequence (Th(Cn−5), Th(Cn−4), Th(Cn−3), Th(Cn−2), Th(Cn−1)) before one span of the presently displaying time code sequence are displayed. Likewise, when pushing a right skip button 33, a time code sequence (Cn+5, Cn+6, Cn+7, Cn+8, Cn+9) after one span of the presently displaying time code sequence and a cut point thumbnail sequence (Th(Cn+5), Th(Cn+6), Th(Cn+7), Th(Cn+8), Th(Cn+9)) are displayed.

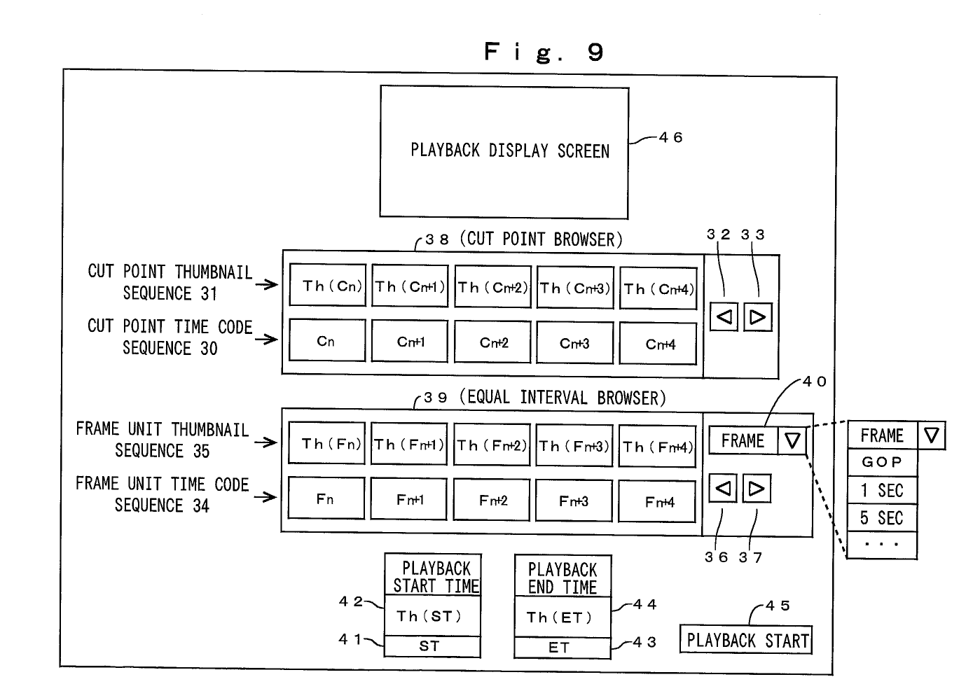

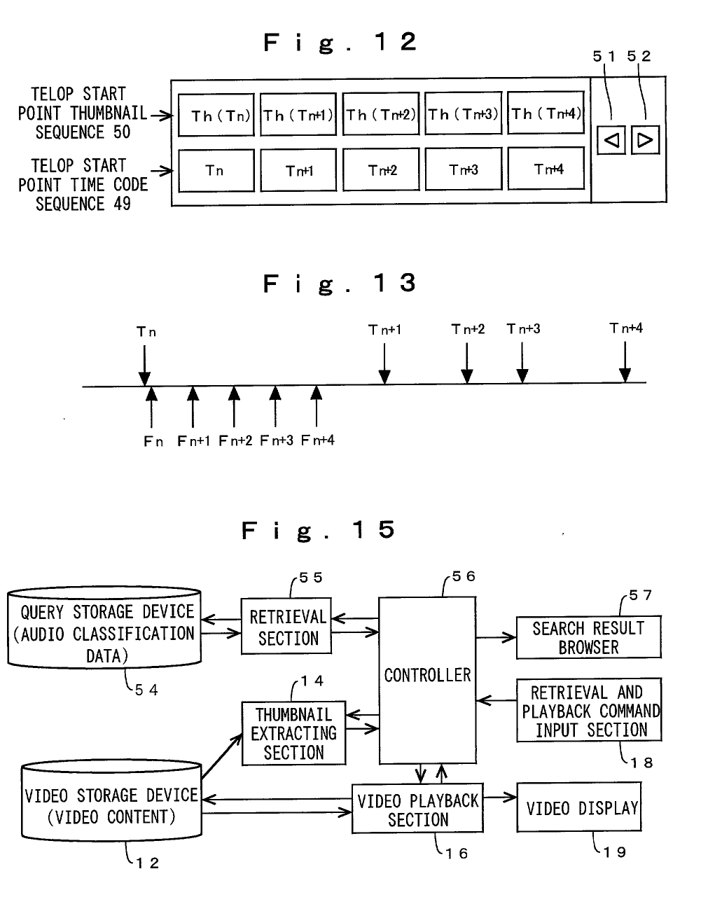

FIG. 7 shows a browsing display example of frame unit retrieval and browsing. A frame unit time code sequence (Fn, Fn+1, Fn+2, Fn+3, Fn+4) 34 is displayed, and simultaneously, a frame unit thumbnail sequence (Th(Fn), Th(Fn+1), Th(Fn+2), Th(Fn+3), Th(Fn+4)) 35 is displayed in synchronous with the above display. When pushing a left skip button 36, a time code sequence (Fn−5, Fn−4, Fn−3, Fn−2, Fn−1) and a thumbnail sequence (Th(Fn−5), Th(Fn−4), Th(Fn−3), Th(Fn−2), Th(Fn−1)) before one span of the presently displaying time code sequence are displayed. Likewise, when pushing a right skip button 37, a time code sequence (Fn+5, Fn+6, Fn+7, Fn+8, Fn+9) and a thumbnail sequence (Th(Fn+5), Th(Fn+6), Th(Fn+7), Th(Fn+8), Th(Fn+9)) after one span of the presently displaying time code sequence are displayed. The frame unit time code browsing display is made using a browsing interval setup menu 40 of FIG. 9. For example, the frame unit time code is changed to a value having equal intervals such as GOP unit, one-second unit, and five-second unit, and thereby, equal interval browsing display is possible with various time precisions.

Further, as seen from FIG. 8 showing a relation between cut point time codes and frame unit time codes, the browsing display in the cut point retrieval and browsing is combined with the equal interval browsing display such as frame unit. By doing so, a time position is roughly specified by the cut point browsing display, and thereafter, time codes can be finely displayed from the time position by the frame unit browsing display.

FIG. 9 shows an example of a video index browser and video player singly or complexly using a cut point browser and a frame unit browser.

A cut point browser 38 is operated in the same manner as the browser described in FIG. 6. The cut point browser 38 is suitable to roughly grasp the contents, and can designate playback start and end positions. In a state of extracting a thumbnail of certain time position on the cut point browser 38, when pushing a playback start time point button 42, the time code is displayed on a playback start point display area 41 while the corresponding thumbnail being displayed on the playback start time point button 42. Likewise, when pushing a playback end time point button 44, the time code is displayed on a playback end point display area 43 while the corresponding thumbnail being displayed on the playback end time point button 44. Subsequently, when pushing a playback start button 45, segment playback from the start point to end point designated by the cut point is started on a playback display screen 46. In the case where the playback start button 45 is pushed without designating the playback start and end position, the whole segment from the head to last of the video contents is played back by the cut point designation.

On the other hand, a frame unit browser 39 is operated in the same manner as the browser described in FIG. 7. When opening a browsing interval setup menu 40, a display time interval such as frame unit, GOP (usually, about 0.5 seconds) unit and five-second unit is displayed, and then, the display is extracted, and thereby, the display time interval can be changed. Hereinafter, the frame unit browser 39 includes a frame unit browsing function; therefore, it is referred to as equal interval browser.

In the cut point browser 38, when extracting a certain thumbnail, equal interval browsing display from the time is made on the equal interval browser 39, and then, time direction contents are finely grasped while playback start and end position being designated. In a state of extracting a thumbnail of certain time position on the equal interval browser 39, when pushing the playback start time point button 42, the time code is displayed on the playback start point display area 41 while the corresponding thumbnail being displayed on the playback start time point button 42. Likewise, when pushing the playback end time point button 44, the time code is displayed on a playback end point display area 43 while the corresponding thumbnail being displayed on the playback end time point button 44. Subsequently, when pushing a playback start button 45, segment playback from the designated start point to end point designated by the frame precision is started on the playback display screen 46. In the case where the playback start button 45 is pushed without designating the playback start and end position, the whole segment from the head to last of the video contents is played back by the cut point designation.

As described above, according to the first embodiment of the video retrieval and browsing apparatus, on the cut point browser 38, it is possible to carry out rough thumbnail retrieval and browsing; on the other hand, on the equal interval browser, it is possible to carry out high precise thumbnail retrieval and browsing at frame unit and second unit. Further, on the equal interval browser 39, it is possible to carry out high precise segment playback by designating the time as playback start and end points. Moreover, the query storage device 11 has no need of previously storing browsing thumbnail such as JPEG; therefore, it is possible to greatly reduce a storage capacity of the query storage device 11.

[Second Embodiment]

Next, the following is a description on a second embodiment of the video retrieval and browsing apparatus. According to this second embodiment, thumbnail retrieval and browsing is carried out using telop query in place of the cut point query described in the above first embodiment, and high precise segment playback is carried out on a local host computer by designating the time as playback start/end point.

In FIG. 10, the video retrieval and browsing apparatus has the same configuration as FIG. 1 excepting a query storage device 47, and is operated in the same manner as that.

A telop query describing a start time of telop scene such as news is previously detected from a video stored previously in the video storage device 12, and then, is stored in the query storage device 47. In this case, there is no need of extracting and saving browsing thumbnail such as JPEG file corresponding to each telop start time code described in the telop query. The telop may be retrieved using the method described in “the intra-video telop area detecting apparatus disclosed in Japanese Patent Application No. 2000-248794” by the present applicant.

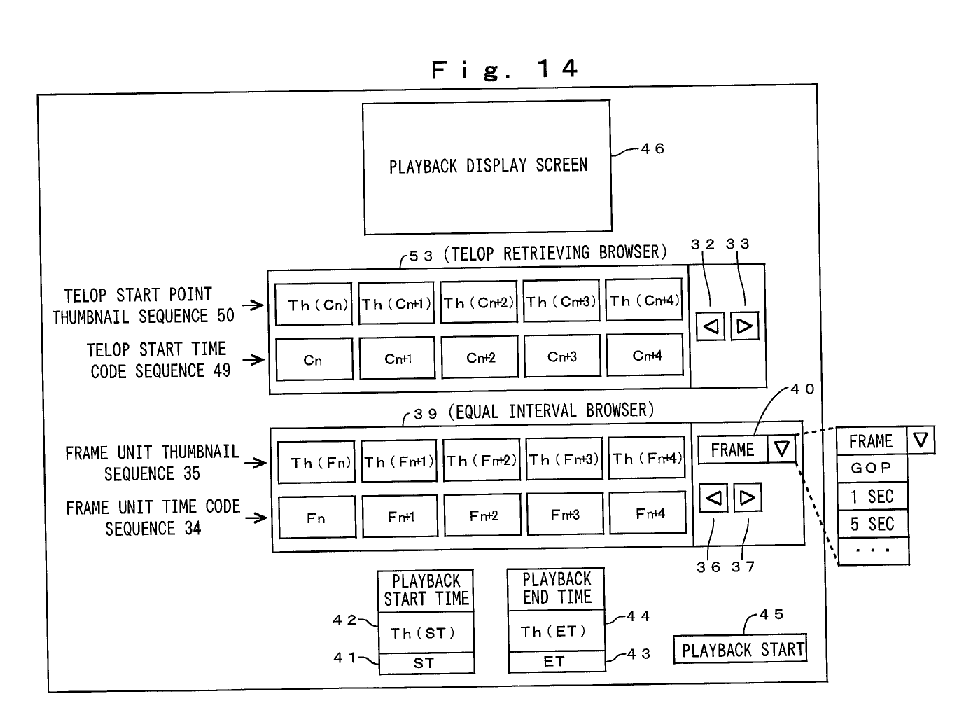

In the telop query description, a telop start point browsing time code sequence (T1, T2, T3, . . . ) 48 as shown in FIG. 11 is used. In the telop start point browsing time code sequence 48, time codes showing the start of scene in which telop appears are arranged in the order of time series in the same manner as the cut point query description (see FIG. 2).

When a video file name is designated from the retrieval and playback command input section 18 and a telop retrieval start command is inputted, the controller 15 outputs telop retrieval start time code and the number of retrievals of telop start point browsing thumbnail to the retrieval section 13. Then, based on the inputted data, the retrieval section 13 obtains a telop start point browsing time code sequence corresponding to thumbnail to be browsed from the telop query stored in the query storage device 47. The controller 15 transfers the obtained telop start point browsing time code sequence to the thumbnail extracting section 14, and then, the corresponding thumbnail sequence is fetched, and thereafter, is displayed as the telop start point retrieval result on the search result browser 17 via the controller 15.

The method of retrieving and browsing finer contents in time direction from the telop start point position or arbitrary position and the video segment playback method are the same as the above first embodiment.

In the thumbnail extracting section 14, mapping between requested time code, frame time code in the video and extracted thumbnail time code is the same as the above first embodiment. Namely, mapping is carried out by substituting the telop start point browsing time code sequence (T1, T2, T3, . . . ) 48 shown in FIG. 11 for the request time code sequence (R1, R2, R3, R4, . . . ) 27 in FIG. 5.

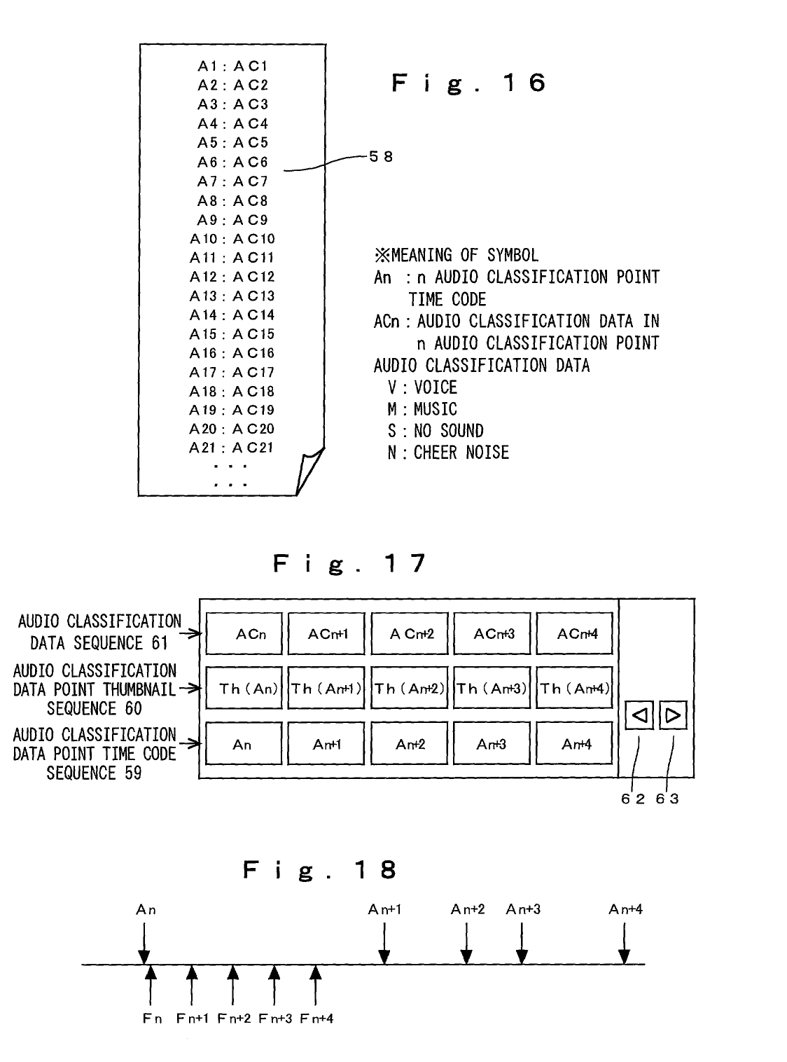

FIG. 12 shows a browsing display example of telop retrieval and browsing. The telop start point browse time code sequence (Tn, Tn+1, Tn+2, Tn+3, Tn+4) 49 is displayed, and simultaneously, a telop start point thumbnail sequence (Th(Tn), Th(Tn+1), Th(Tn+2), Th(Tn+3), Th(Tn+4)) 50 is displayed in synchronous with the above display. When pushing a left skip button 51, a time code sequence (Tn−5, Tn−4, Tn−3, Tn−2, Tn−1) and a telop start point thumbnail sequence (Th(Tn−5), Th(Tn−4), Th(Tn−3), Th(Tn−2), Th(Tn−1)) before one span of the presently displaying time code sequence are displayed. Likewise, when pushing a right skip button 52, a time code sequence (Tn+5, Tn+6, Tn+7, Tn+8, Tn+9) and a telop start point thumbnail sequence (Th(Tn+5), Th(Tn+6), Th(Tn+7), Th(Tn+8), Th(Tn+9)) after one span of the presently displaying time code sequence are displayed.

Further, as seen from FIG. 13 showing a relation between telop start point time codes and frame unit time codes, the browsing display in the telop retrieval and browsing is combined with the equal interval browsing display such as frame unit described in the first embodiment (see FIG. 7). By doing so, a time position (such as head position of each item in news) is roughly specified by the telop start point browsing display, and thereafter, time codes can be finely displayed from the time position by the frame unit browsing display.

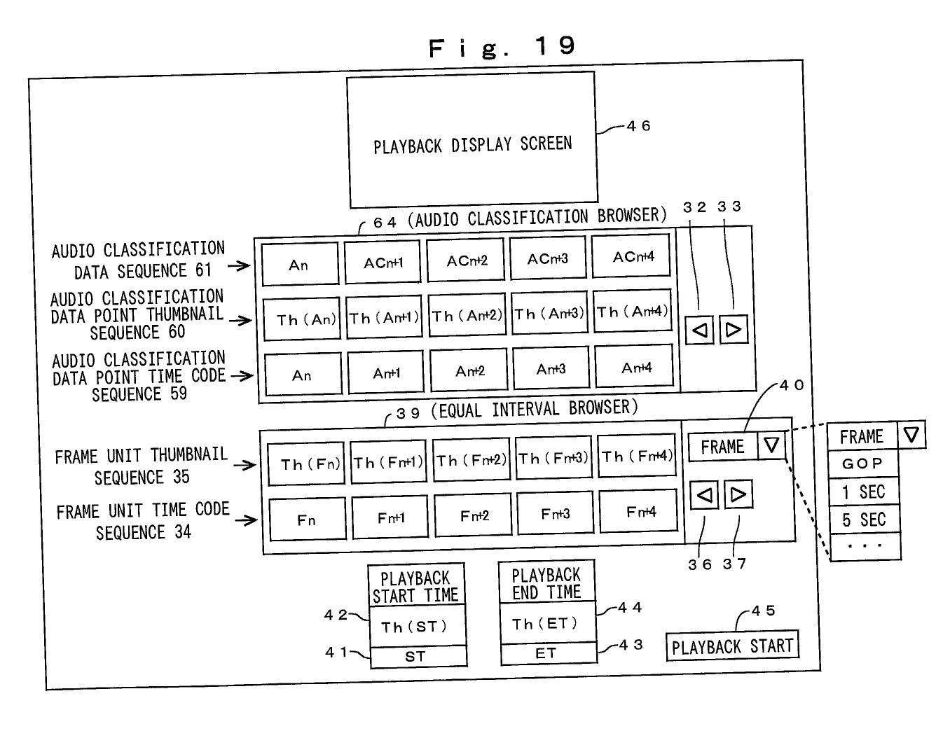

FIG. 14 shows an example of a video index browser and video player singly or complexly using a telop retrieving browser and a frame unit browser.

The telop retrieving browser 53 is the same operation as that described in FIG. 12. The telop retrieving browser 53 cues up each item in news video having a probability such that telop appears in the beginning of scene changed, and can designate playback start and end positions. In a state that a thumbnail of certain position is selected on the telop retrieving browser 53, when pushing the playback start time point button 42, the time code is displayed on the playback start point display area 41 while the corresponding thumbnail being displayed on the playback start time point button 42. Likewise, when pushing the playback end time point button 44, the time code is displayed on a playback end point display area 43 while the corresponding thumbnail being displayed on the playback end time point button 44. Subsequently, when pushing the playback start button 45, segment playback from the start point to end point designated by telop start point is started on the playback display screen 46. In the case where the playback start button 45 is pushed in a state of designating only playback start position, the segment playback from the designated start point to the last of contents is carried out. On the other hand, in the case where the playback start button 45 is pushed without designating the playback start and end position, the whole segment from the head to last of the video contents is played back.

The operation of the equal interval browser 39 making the frame unit display is the same as the above first embodiment.

[Third Embodiment]

Next, the following is a description on a third embodiment of the video retrieval and browsing apparatus. According to this third embodiment, thumbnail retrieval and browsing is carried out using audio classification data in place of the cut point query described in the above first embodiment, and high precise segment playback is carried out on a local host computer by designating the time as playback start/end point.

In FIG. 15, the video retrieval and browsing apparatus has the same configuration as FIG. 1 excepting a query storage device 54, a retrieval section 55, a controller 56 and a search result browser 57, and is operated in the same manner as that. Audio classification data showing where audio belongs to any classes of voice, music, cheer noise and no sound is previously detected from video image previously stored in the video storage device 12, and then, the detected data is saved in the query storage device 54. In this case, there is no need of extracting and saving browsing thumbnail such as JPEG file corresponding to classification point time code described in the audio classification data. The audio data may be classified using the method described in “the audio data classifying apparatus disclosed in Japanese Patent Application Laid-Open No. 2000-66691” by the present applicant.

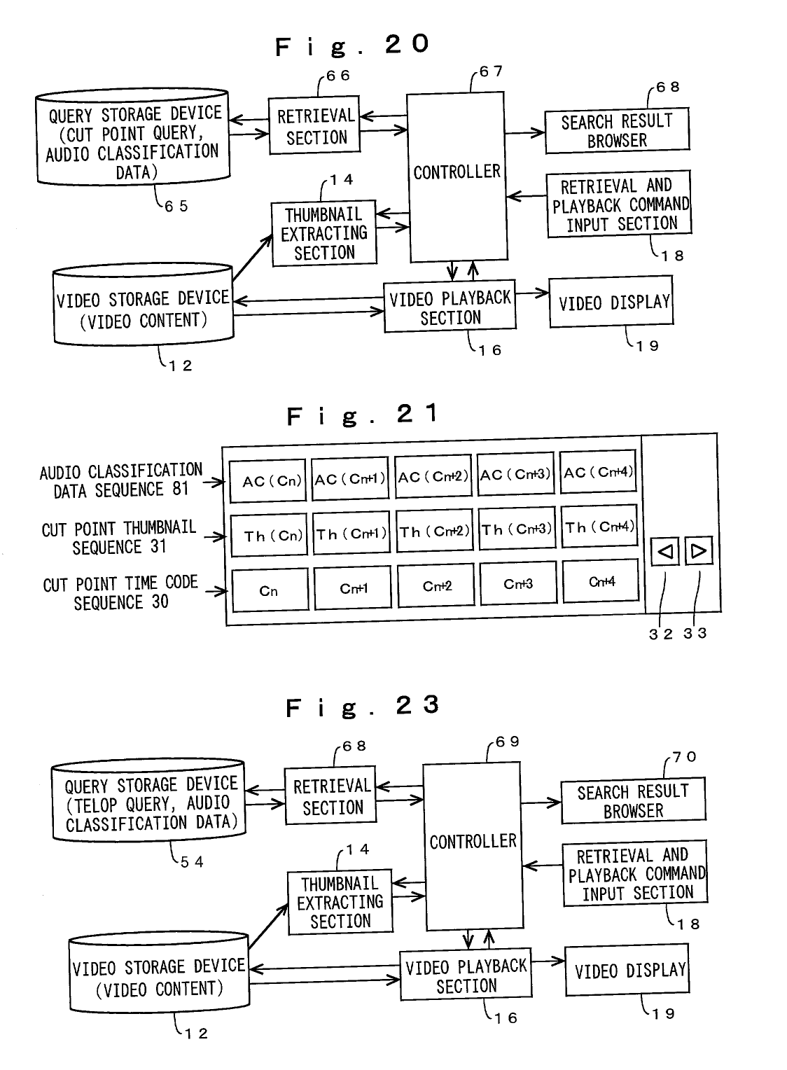

In the audio classification data, an audio classification data sequence (A1:AC1, A2:AC2, A3:AC3, . . . ) 58 such as every one second as shown in FIG. 16 is used. In this case, the audio data is classified into data such as “voice”, “music”, “cheer noise” and “no sound”. In FIG. 16, a symbol “An” denotes n audio classification point time code, and a symbol “ACn” denotes an audio classifying data in n audio classification point.

When a video file name is designated from the retrieval and playback command input section 18 and an audio classification start command is inputted, the controller 56 outputs an audio classification start time code and the number of retrievals of audio classification point browsing thumbnail to the retrieval section 55. Then, based on the inputted data, the retrieval section 55 obtains an audio classification point browsing time code sequence (An, An+1, An+3,) corresponding to thumbnail to be browsed and an audio classifying data sequence (ACn+1, ACn+2, ACn+3,) corresponding to each time code sequence from the audio classification data stored in the query storage device 54. The controller 56 transfers the obtained audio classification point browsing time code sequence (An, An+1, An+3, . . . ) to the thumbnail extracting section 14, and then, the corresponding thumbnail sequence (Th(An), Th(An+1), Th(An+3), . . . ) is fetched. Thereafter, the fetched thumbnail sequence is browse-displayed as the audio classification point retrieval result on the search result browser 57 together with the audio classifying data sequence (ACn+1, ACn+2, ACn+3,) via the controller 56.

The method of retrieving and browsing finer contents in time direction from the audio classification point position or arbitrary position and the video segment playback method are the same as the above first embodiment.

In the thumbnail extracting section 14, mapping between requested time code, frame time code in the video and extracted thumbnail time code is the same as the above first embodiment. Namely, mapping is carried out by substituting the audio classification point time code sequence (A1, A2, A3, . . . ) 58 shown in FIG. 16 for the request time code sequence (R1, R2, R3, R4, . . . ) 27 in FIG. 5.

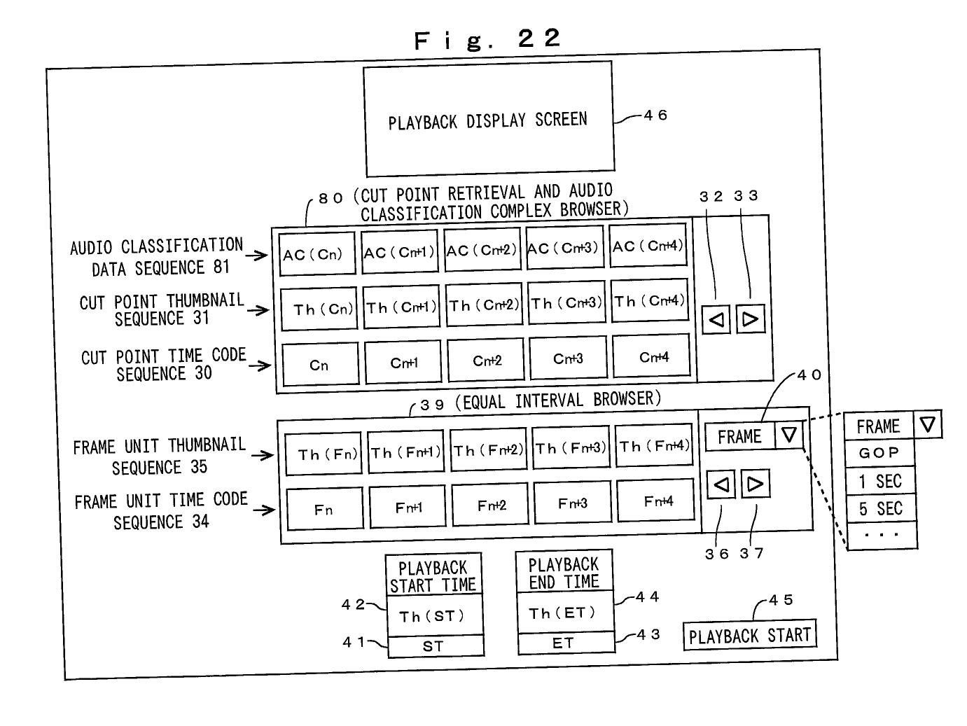

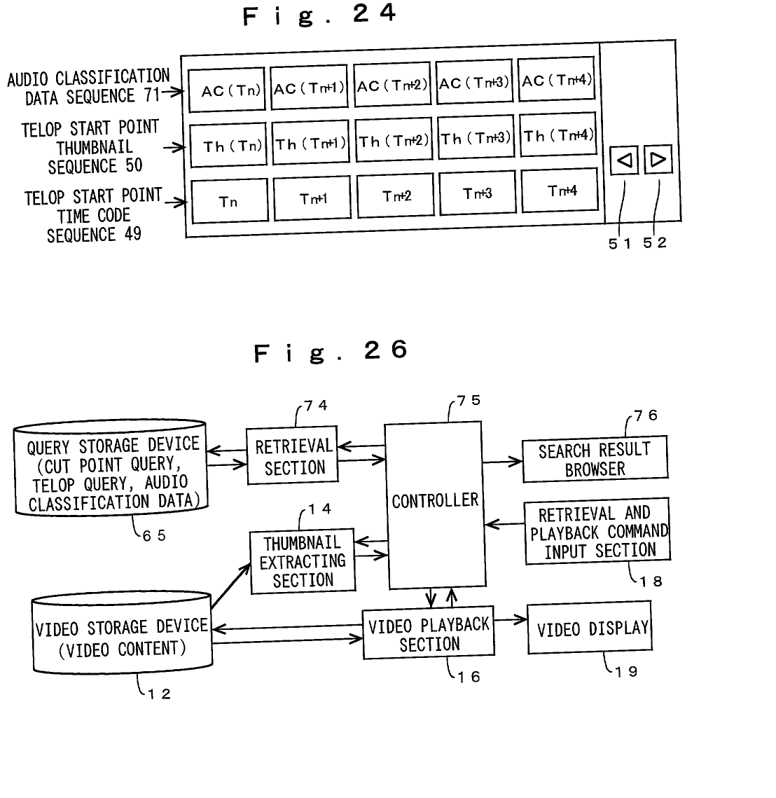

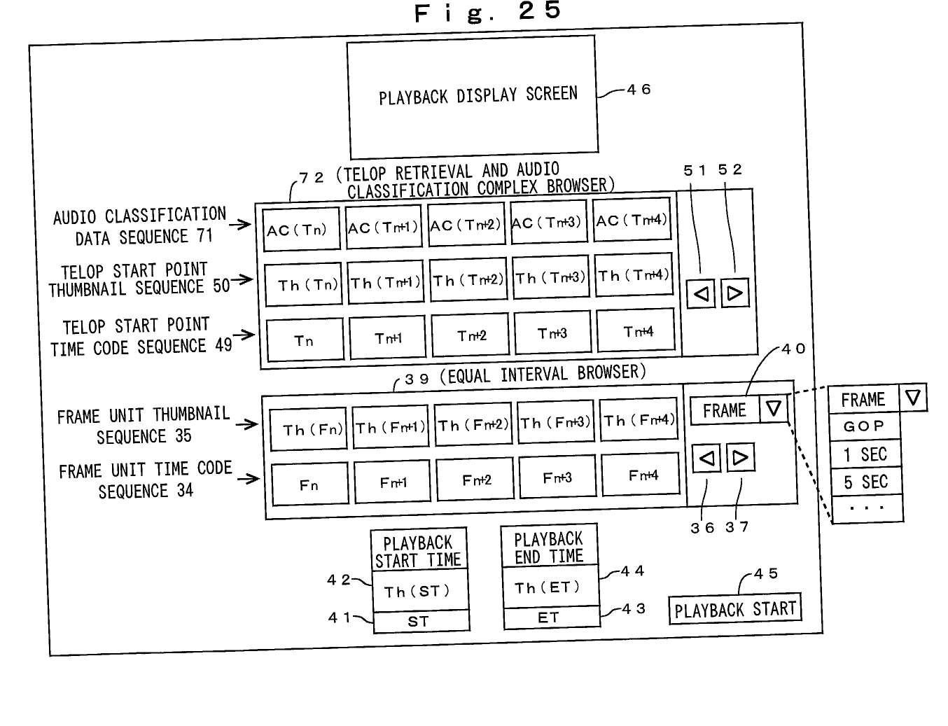

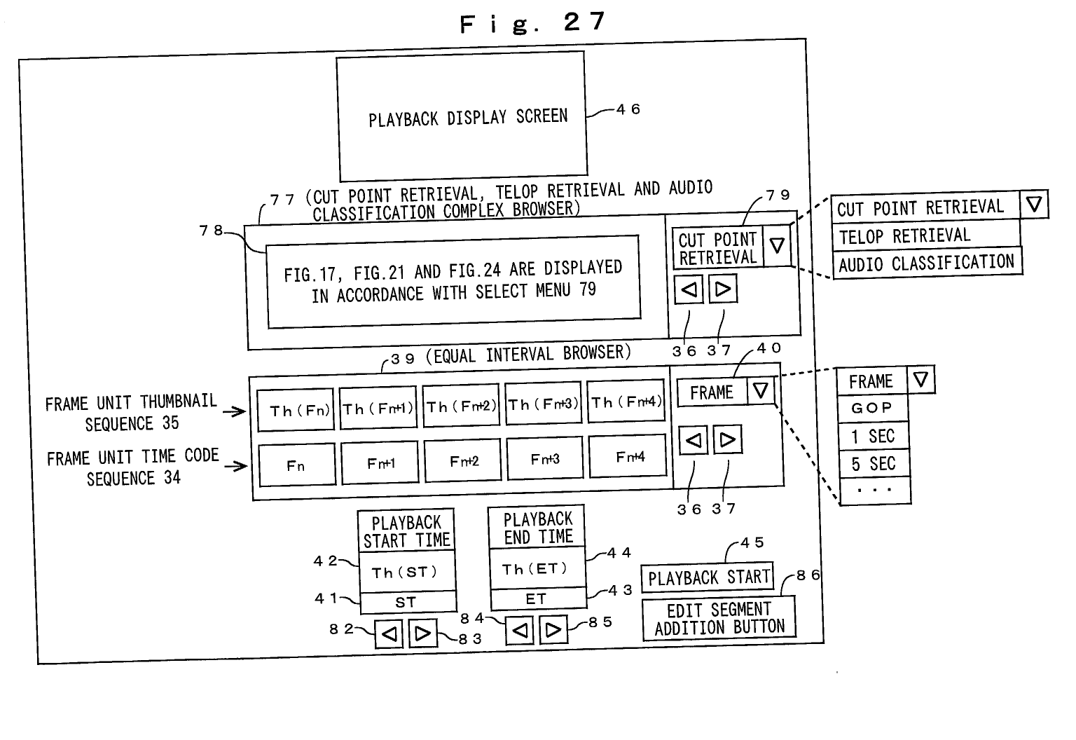

FIG. 17 shows a browsing display example of audio classification. An audio classification point time code sequence (An, An+1, An+2, An+3, An+4) 59 is displayed, and simultaneously, an audio classification point thumbnail sequence (Th(An), Th(An+1), Th(An+2), Th(An+3), Th(An+4)) 60 and an audio classification data sequence (ACn, ACn+1, ACn+2, ACn+3, ACn+4) 61 are displayed in synchronous with the above display. When pushing a left skip button 62, a time code sequence (An−5, An−4, An−3, An−2, An−1), an audio classification point thumbnail sequence (Th(An−5), Th(An−4), Th(An−3), Th(An−2), Th(An−1)) and an audio classification data sequence (ACn−5, ACn−4, ACn−3, ACn−2 ACn−1) before one span of the presently displaying time code sequence are displayed. Likewise, when pushing a right skip button 63 a time code sequence (An+5, An+6, An+7, An+8, An+9), an audio classification point thumbnail sequence (Th(An+5), Th(An+6), Th(An+7), Th(An+8), Th(An+9)) and an audio classification data sequence (ACn+5, ACn+6, ACn+7, ACn+8 ACn+9) after one span of the presently displaying time code sequence are displayed.

Moreover, in the frame unit retrieval browsing described in the above first embodiment, as seen from the relation between audio classification data point time codes and frame unit time codes of FIG. 18, audio classification browsing display is combined with equal interval browsing display such as frame unit. By doing so, a rough time position (e.g., point changing from MC's voice to musician's playing) is specified by the audio classification point browsing display, and then, the time code may be finely displayed from the position by the frame time browsing display.

FIG. 19 shows an example of a video index browser and video player singly or complexly using the audio classification browser and the frame unit browser.

An audio classification browser 64 is the same operation as that described in FIG. 17. The audio classification browser 64 displays a scene changing point by voice classification using thumbnail and audio classification data, and can designate playback start and end positions. In a state that a thumbnail of certain position is selected on the audio classification browser 64, when pushing the playback start time point button 42, the time code is displayed on the playback start point display area 41 while the corresponding thumbnail being displayed on the playback start time point button 42. Likewise, when pushing the playback end time point button 44, the time code is displayed on a playback end point display area 43 while the corresponding thumbnail being displayed on the playback end time point button 44. Subsequently, when pushing the playback start button 45, segment playback from the start point to end point designated by the audio classification data changing point is started on the playback display screen 46. In the case where the playback start button 45 is pushed in a state of designating only playback start position, the segment playback from the designated start point to the last of contents is carried out. On the other hand, in the case where the playback start button 45 is pushed without designating the playback start and end position, the whole segment from the head to last of the video contents is played back.

The operation of the equal interval browser 39 making the frame unit display is the same as the above first embodiment; therefore, the details are omitted.

[Fourth Embodiment]

Next, the following is a description on a fourth embodiment of the video retrieval and browsing apparatus. According to this fourth embodiment, thumbnail retrieval and browsing and high precise segment playback by designating the time as playback start/end point are carried out on a local host computer using complexly the cut point query described in the above first embodiment and the audio classification data described in the above third embodiment.

In FIG. 20, the video retrieval and browsing apparatus has the same configuration as FIG. 1 excepting a query storage device 65, a retrieval section 66, a controller 67 and a search result browser 68, and is operated in the same manner as that. The query storage device 65 is stored with cut point query and audio classification data. The retrieval section 66, the controller 67 and the search result browser 68 individually include all functions described in the above first and third embodiments.

FIG. 21 shows an example of a complex browsing display of the cut point browser and the audio classification browser. In FIG. 21, the operation of the cut point time code sequence 30 and the cut point thumbnail sequence 31 are the same as that of FIG. 6. An audio classification data sequence (AC(Cn) AC(Cn+1), AC(Cn+2), AC(Cn+3), AC(Cn+4), . . . ) 81 corresponding to the cut point time code sequence is displayed synchronous with the cut point time code sequence (Cn, Cn+1, Cn+2, Cn+3, Cn+4) 30 and the cut point thumbnail sequence (Th(Cn), Th(Cn+1), Th(Cn+2), Th(Cn+3), Th(Cn+4)). When pushing a left skip button 32, a time code sequence (Cn−5, Cn−4, Cn−3, Cn−2, Cn−1), a cut point thumbnail sequence (Th(Cn−5), Th(Cn−4), Th(Cn−3), Th(Cn−2), Th(Cn−1)) and an audio classification data sequence (AC(Cn−5), AC(Cn−4), AC(Cn−3), AC(Cn−2), AC(Cn−1)) before one span of the presently displaying time code sequence are displayed. Likewise, when pushing a right skip button 33, a time code sequence (Cn+5, Cn+6, Cn+7, Cn+8, Cn+9), a cut point thumbnail sequence (Th(Cn+5), Th(Cn+6), Th(Cn+7), Th(Cn+8), Th(Cn+9)) and an audio classification data sequence (AC(Cn+5), AC(Cn+6), AC(Cn+7), AC(Cn+8), AC(Cn+9))after one span of the presently displaying time code sequence are displayed. In this case, the audio classification data AC(Cn) in the cut point time Cn is obtained from ACm (m audio classification data) shown in the following equation (5) using m (m audio classification point) satisfying the following equation (4).

Am≦Cn<Am+1 (4)

AC(Cn)=ACm (5)

FIG. 22 shows a video index browser and video player complexly using the cut point browser, the audio classification browser and the frame unit browser.

A cut point retrieval and audio classification complex browser 80 is the same operation as that described in FIG. 21. The complex browser 80 displays a scene changing point by the cut point using thumbnail and audio classification data, and can designate playback start and end positions. In a state that a thumbnail of certain position is selected on the complex browser 80, when pushing the playback start time point button 42, the time code is displayed on the playback start point display area 41 while the corresponding thumbnail being displayed on the playback start time point button 42. Likewise, when pushing the playback end time point button 44, the time code is displayed on a playback end point display area 43 while the corresponding thumbnail being displayed on the playback end time point button 44. Subsequently, when pushing the playback start button 45, segment playback from the start point to endpoint designated by the cut point is started on the playback display screen 46. In the case where the playback start button 45 is pushed in a state of designating only playback start position, the segment playback from the designated start point to the last of contents is carried out. On the other hand, in the case where the playback start button 45 is pushed without designating the playback start and end position, the whole segment from the head to last of the video contents is played back.

The operation of the equal interval browser 39 making the frame unit display is the same as the above first embodiment; therefore, the details are omitted.

[Fifth Embodiment]

Next, the following is a description on a fifth embodiment of the video retrieval and browsing apparatus. According to this fifth embodiment, thumbnail retrieval and browsing and high precise segment playback by designating the time as playback start/end point are carried out on a local host computer using complexly the telop query described in the above second embodiment and the audio classification data described in the above third embodiment.

In FIG. 23, the video retrieval and browsing apparatus has the same configuration as FIG. 10 excepting a query storage device 67, a retrieval section 68, a controller 69 and a search result browser 70, and is operated in the same manner as that. The query storage device 67 is stored with telop query and audio classification data. The retrieval section 68, the controller 69 and the search result browser 70 individually include all functions described in the above first and third embodiments.

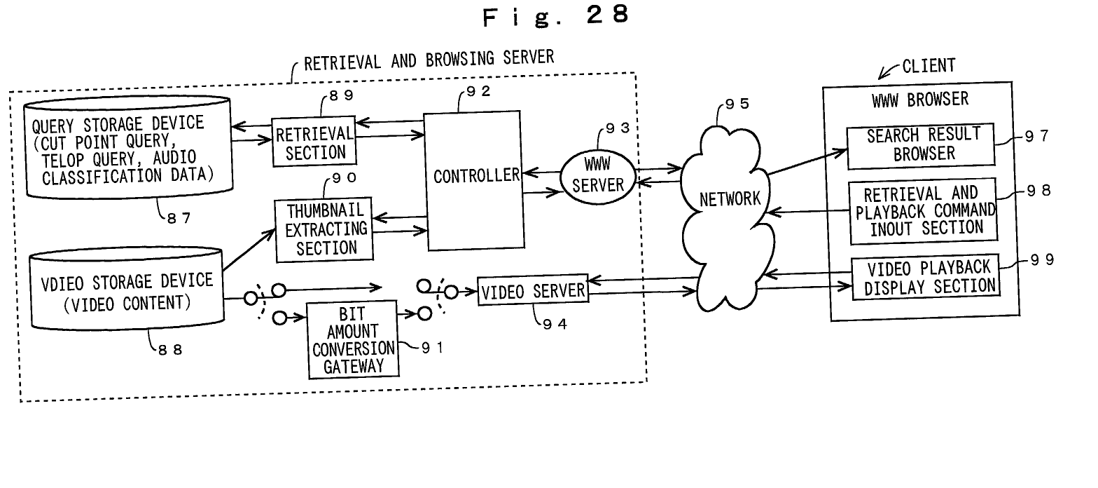

FIG. 24 shows an example of a complex browsing display of the telop retrieving browser and the audio classification browser. In FIG. 24, the operation of the telop start point time code sequence 49 and the telop start point thumbnail sequence 50 are the same as that of FIG. 12. An audio classification data sequence (AC(Tn) AC(Tn+1), AC(Tn+2), AC(Tn+3), AC(Tn+4), . . . ) 71 corresponding to the telop start point time code sequence is displayed synchronous with the telop start point time code sequence (Tn, Tn+1, Tn+2, Tn+3, Tn+4) 49 and the telop start point thumbnail sequence (Th(Tn), Th(Tn+1), Th(Tn+2), Th(Tn+3), Th(Tn+4)) 50. When pushing a left skip button 51, a time code sequence (Tn−5, Tn−4, Tn−3, Tn−2, Tn−1), a telop start point thumbnail sequence (Th(Tn−5), Th(Tn−4), Th(Tn−3), Th(Tn−2), Th(Tn−1)) and an audio classification data sequence (AC(Tn−5), AC(Tn−4), AC(Tn−3), AC(Tn−2), AC(Tn−1)) before one span of the presently displaying time code sequence are displayed. Likewise, when pushing a right skip button 52, a time code sequence (Tn+5, Tn+6, Tn+7, Tn+8, Tn+9), a telop start point thumbnail sequence (Th(Tn+5), Th(Tn+6), Th(Tn+7), Th(Tn+8), Th(Tn+9)) and an audio classification data sequence (AC(Tn+5), AC(Tn+6), AC(Tn+7), AC(Tn+8), AC(Tn+9)) after one span of the presently displaying time code sequence are displayed. In this case, the audio classification data AC(Tn) in the telop start point time Tn is obtained from ACm (m audio classification data) shown in the following equation (7) using m (m audio classification point) satisfying the following equation (6).

Am≦Tn<Am+1 (6)

AC(Tn)=ACm (7)

FIG. 25 shows a video index browser and video player complexly using the telop retrieval point browser, the audio classification browser and the frame unit browser.

A telop retrieval and audio classification complex browser 72 is operated in the same manner as FIG. 24, and displays a scene changing point such as news by the telop start point using thumbnail and audio classification data, and can designate playback start and end positions. In a state that a thumbnail of certain time position is selected on the telop retrieval and audio classification complex browser 72, when pushing the playback start time point button 42, the time code is displayed on the playback start point display area 41 while the corresponding thumbnail being displayed on the playback start time point button 42. Likewise, when pushing the playback end time point button 44, the time code is displayed on a playback end point display area 43 while the corresponding thumbnail being displayed on the playback end time point button 44. Subsequently, when pushing the playback start button 45, segment playback from the start point to end point designated by the telop start point is started on the playback display screen 46. In the case where the playback start button 45 is pushed without designating the playback start and end position, the whole segment from the head to last of the video contents is played back.

The operation of the equal interval browser 39 making the frame unit display is the same as the above first embodiment; therefore, the details are omitted.

[Sixth Embodiment]

Next, the following is a description on a sixth embodiment of the video retrieval and browsing apparatus. According to this sixth embodiment, thumbnail retrieval and browsing is carried out using complexly the cut point query described in the first embodiment, the telop query described in the above second embodiment and the audio classification data described in the above third embodiment. Further, high precise segment playback by designating the time as playback start/end point is carried out on a local host computer.

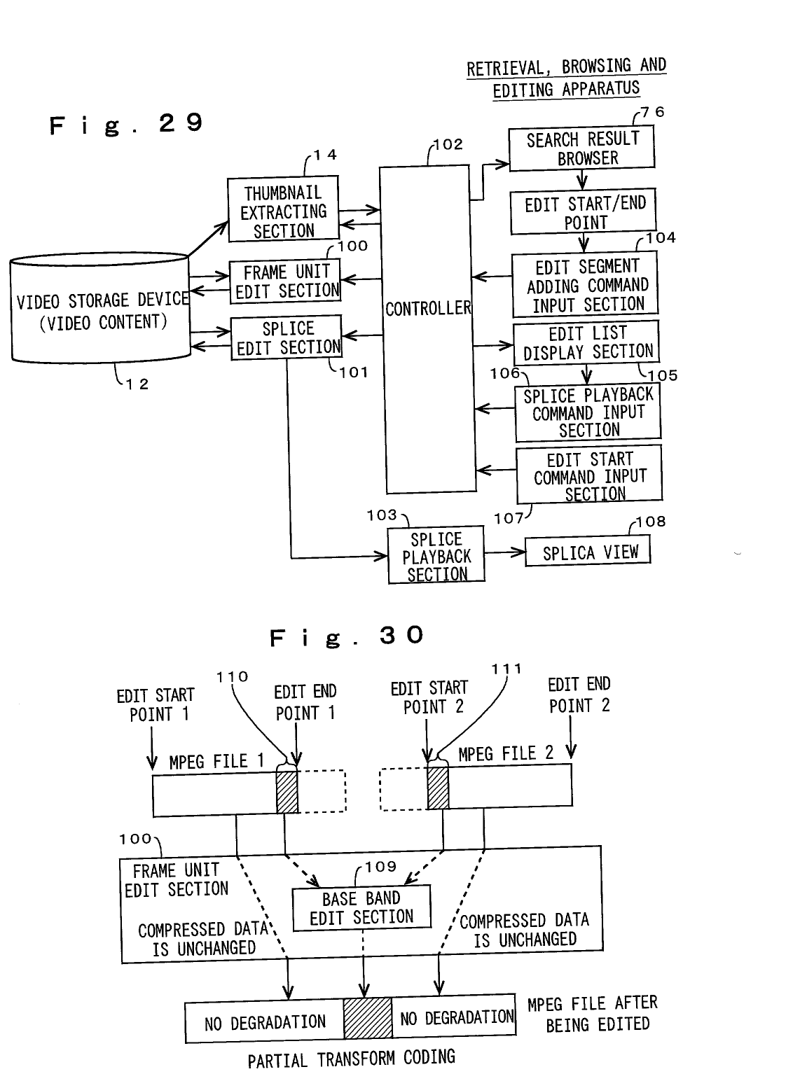

In FIG. 26, the video retrieval and browsing apparatus has the same configuration as FIG. 1 excepting a query storage device 73, a retrieval section 74, a controller 75 and a search result browser 76, and is operated in the same manner as that. The query storage device 73 is stored with cut point query, telop query and audio classification data. The retrieval section 74, the controller 75 and the search result browser 76 individually include all functions described in the above first to third embodiments.

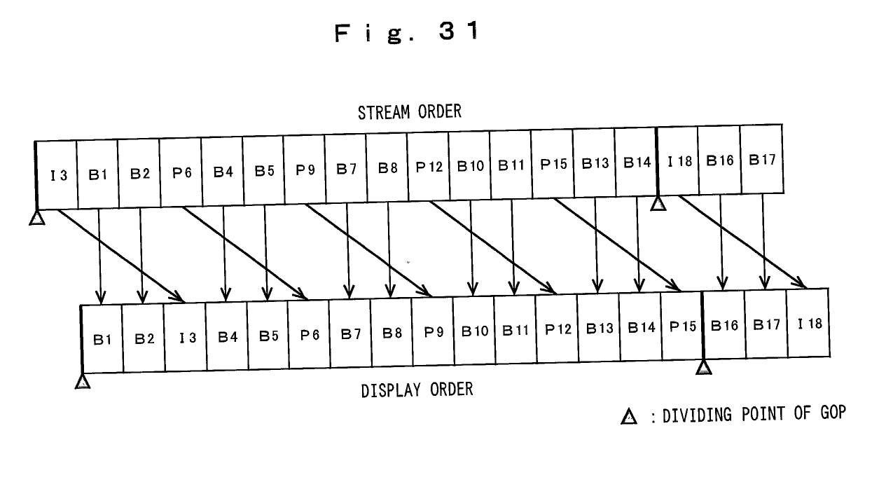

FIG. 27 shows an example of a video index browser and video player complexly using the cut point retrieval browser, the telop retrieval browser, the audio classification browser and the frame unit browser.

A cut point retrieval, telop retrieval and audio classification complex browser 77 selects a retrieval and browsing method (cut point retrieval, telop retrieval, audio classification browsing) in a retrieval and browsing method extract menu 79, and thereby, each operation of an internal browsing display section 78, a left skip button 36 and a right skip button 37 is changed.

In the operation of the internal browsing display section 78 in each retrieval and browsing method, cut point retrieval is the same as FIG. 21, telop retrieval is the same as FIG. 24, and audio classification browsing is the same as FIG. 17.

In a state that a thumbnail of certain time position is selected on the cut point retrieval-telop retrieval-audio classification complex browser 77, when pushing the playback start time point button 42, the time code is displayed on the playback start point display area 41 while the corresponding thumbnail being displayed on the playback start time point button 42. In the case of making fine adjustment of frame unit of the playback start point, frame skip buttons 82 and 83 are used. Likewise, when pushing the playback end time point button 44, the time code is displayed on a playback end point display area 43 while the corresponding thumbnail being displayed on the playback end time point button 44. In the case of making fine adjustment of frame unit of the playback end point, frame skip buttons 84 and 85 are used. Subsequently, when pushing the playback start button 45, segment playback from the start point to end point designated by the cut point, telop start point and the audio classification changing point is started on the playback display screen 46. In the case where the playback start button 45 is pushed in a state of designating only playback start position, the segment playback from the designated start point to the last of contents is carried out. On the other hand, in the case where the playback start button 45 is pushed without designating the playback start and end position, the whole segment from the head to last of the video contents is played back. The operation of edit segment addition button 86 will be described in the following eighth embodiment.

The operation of the equal interval browser 39 making the frame unit display is the same as the above first embodiment; therefore, the details are omitted.

[Seventh Embodiment]

Next, a seventh embodiment of the present invention will be described with reference to FIG. 28.

According to this seventh embodiment, thumbnail retrieval and browsing and high precise segment playback by designating the time as playback start/end point is carried out using complexly the cut point query, the telop query, the audio classification data and frame unit retrieval described in the above first to sixth embodiments. Further, the thumbnail retrieval and browsing and segment playback are applied to server client computer on the network.

In FIG. 28, a video storage device 88 is previously stored with video contents. Various query such as the cut point query, the telop query and the audio classification data are detected from the stored video image, and then, the detected data is saved in a query storage device 87. In this case, there is no need of extracting and saving browsing thumbnail such as JPEG file corresponding to time codes included in various query. Various retrieval classification data description is the same as the first to sixth embodiments.

A video file name is designated from a retrieval and playback command input section 98 on client side WWW browser, and various retrieval start commands are inputted to a controller 92 via a network 95 and a WWW server 93. Whereupon the controller 92 outputs various retrieval and classification start time codes and the number of retrievals of various retrieval and classification browsing thumbnail to a retrieval section 89. Then, based on the inputted data, the retrieval section 89 obtains a browsing time code sequence corresponding to thumbnail to be browsed from various query stored in the query storage device 87. The controller 92 transfers the obtained browsing time code sequence to the thumbnail extracting section 90, and then, the corresponding thumbnail sequence is fetched. Thereafter, the time code is browse-displayed as various retrieval and classification results on the search result browser 97 on the WWW browser 96 via the controller 92, the WWW server 93 and the network 95.

In the case of retrieving, classifying and browsing further detailed contents in a time direction from various retrieval and classification point positions or arbitrary position, a retrieval and playback command input section 98 on the WWW browser 96 inputs the following information to the controller 92 via the network 95 and the WWW Server 93. More specifically, the information includes time codes of the detailed retrieval, classification and browsing start position, display precision of time directions such as frame unit and second unit, and the number of retrievals of browsing thumbnail. Then, the controller 92 generates a browsing time code sequence having a predetermined time interval from the obtained data, and thereafter, transfers the obtained browsing time code sequence to the thumbnail extracting section 90. Further, the corresponding thumbnail sequence is fetched, and then, is transferred to the search result browser 97 via the controller 92, the WWW server 93 and the network 95 so that it is browse-displayed as the retrieval result of predetermined time interval.

In the case of carrying out video segment playback, a video playback start time code and a video playback end time code are obtained on the browse-display of the search result browser 97 on the WWW browser 96. Whereupon the retrieval and playback command input section 98 on the WWW browser 96 inputs playback start and end time codes and playback start command data including video file name data to a video server 94 via the network 95. The video server 94 extracts a segment data designated by frame precision of designated video contents from video content storage 88, and thereafter, transmits the segment data to a video playback display section 99 on the WWW browser 96 via the network 95. At that time, if a transmission band of the extracted video exceeds an output network transmission band, a bit amount conversion gateway 91 makes a bit amount conversion so that the transmission band is adaptable to the network transmission band, and thereafter, outputs it. In this case, the video bit amount conversion may be made using the method described in “video coding data rate conversion method and apparatus disclosed in Japanese Patent Application Laid-Open No. 8-251587” by the present applicant. The video playback display section 99 plays back the received data in succession, and thereby, carries out frame precision segment playback from the playback start point to the playback end point.

The following is a description on the embodiment of actually implementing these devices as system. The controller 92 and the retrieval section 89 are implemented by ASP (Active Server Page, script language such as JavaScript) dynamically adaptable to interactive operation with the WWW browser 96 via the WWW server 93. Then, the thumbnail extracting section 90 implemented by library module accessible from ASP such as ATL (Active Template Library) is controlled from the ASP of the controller 92. In order to achieve high-speed retrieval, the query storage device 87 stores the query in database, and makes a retrieval request from the ASP of the retrieval section 89 in the format of SQL using an ODBC (Open Database Connectivity) function. The video storage device 88 preferably uses an HDD having RAID (Redundant Arrays of Inexpensive Disks) configuration in view of improving performance when a large number of random accesses is simultaneously made from the video server 94 and the thumbnail extracting section 90.

The first to seventh embodiments have described with reference to the accompanying drawings. However, the detailed configuration is not limited to the above first to seventh embodiments.

For example, in the above first to seventh embodiments, a thumbnail extracting program is recorded in a computer readable recording medium as shown in FIG. 42, and then, a computer 200 shown in FIG. 42 may read and execute the thumbnail extracting program recorded in a recording medium 300. In this case, the thumbnail extracting program is a program for realizing the function of the thumbnail extraction section shown in FIG. 1, FIG. 3, FIG. 10, FIG. 15, FIG. 20, FIG. 26 and FIG. 28.

The computer 200 shown in FIG. 42 comprises a CPU 201, an input device 202 such as keyboard and mouse, a ROM (Read Only Memory) 203,a RAM (RandomAccess Memory) 204, a reader 205, an output device 206 such as display and printer, and a bus (BUS) connecting each device. More specifically, the CPU 201 executes the above transmission program, and the ROM 203 stores various data. Further, the RAM 204 stores operation parameters, and the reader 205 reads a transmission program from the recording medium 300.

The CPU 201 reads the thumbnail extracting program recorded in the recording medium 300 via the reader 205, and thereafter, executes the read thumbnail extracting program, and thereby, the above thumbnail extracting process is carried out.

As is evident from the above description, in the video retrieval and browsing apparatus of the present invention, it is possible to achieve low resource retrieval and browsing by extracting the thumbnail in real time, and to achieve high and effective retrieval and browsing on various video content base. Therefore, the following effects can be obtained.

(1) Thumbnail retrieval and browsing is carried out using the query (e.g., cut point time code) such as cut point detected from the video contents such as MPEG stored in the storage device, and then, the thumbnail data required for browse-display is extracted from the video contents. By doing so, it is possible to realize thumbnail retrieval and browsing without previously preparing and saving thumbnail data. Further, it is possible to realize high-precise thumbnail retrieval and browsing at frame unit and second unit.

(2) The browsing time of the thumbnail retrieval and browsing is designated as playback start point and end point, and thereby, high-precise segment playback can be achieved.

(3) The cut point query, query by telop such as news, and audio classification data are employed as query used for the above thumbnail retrieval and browsing, and thereby, various thumbnail retrieval and browsing can be achieved.

(4) It is possible to achieve designated segment playback using the time of the thumbnail retrieval and browsing of the above item (3) as playback start point and end point.

(5) The cut point retrieval, telop retrieval, audio classification retrieval and equal interval retrieval such as frame unit retrieval are complexly combined, and thereby, it is possible to hierarchally and effectively achieve retrieval and browsing from rough outline grasping retrieval to fine time direction retrieval.

(6) The processing from the above items (1) to (5) is not only carried out on the local host computer, but also is carried out on the network in a state of having video data in common.

(7) The program recorded in the recording medium is read into the computer, and thereby, the present invention can be realized on computers such as personal computers.

Next, the following is a description on an eighth embodiment of the present invention. According to this eighth embodiment, edit start/end points are effectively accurately designated using thumbnail retrieval and browsing result using cut point retrieval, telop retrieval, audio classification retrieval and frame unit retrieval described in the above first to sixth embodiments, and then, video edit is carried out.

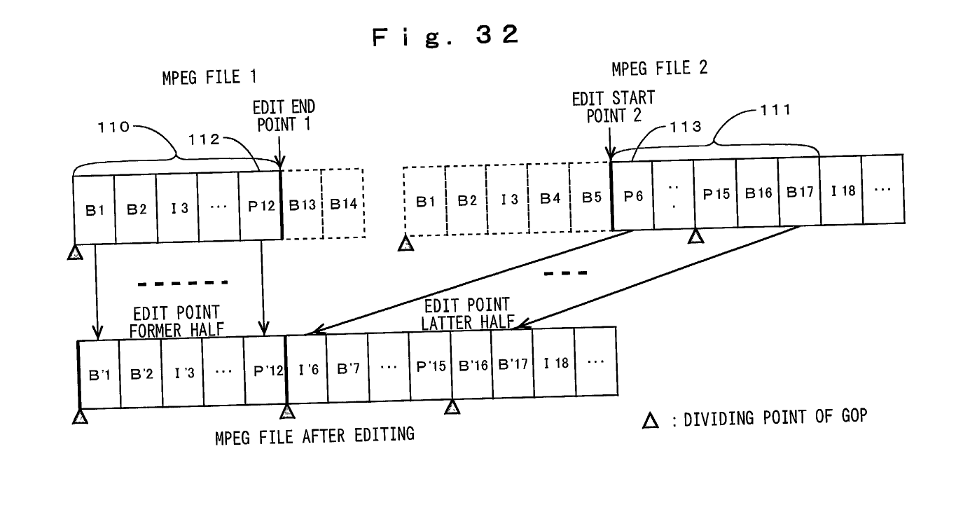

In FIG. 29, each operation of the thumbnail extracting section 14, the search result browser 76 and the video storage device 12 is the same as FIG. 26. The search result browser 76 finds frame-precision edit start/end points out of the retrieval or search result such as the cut point retrieval, telop retrieval, audio classification retrieval and frame unit retrieval, thumbnail-browsed, and then, inputs the time codes and file name to the controller 102 via an edit segment adding command input section 104. The controller 102 extracts the edit start/end points and the thumbnail having content head time code from the thumbnail extracting section 14 together with the added edit segment time code, and thereafter, additionally transmits it to an edit list display section 105. The edit segment adding operation is repeatedly made, and thereafter, in order to check visual consistency of each edit point (each joint portion) in video playback, confirmation is carried out by splice edit (partial edit of joint portion) and splice playback (partial playback of joint portion).

The splice edit/playback processing will be described below. A splice playback command input section 106 inputs to the splice edit section 101 a splice playback command (partial playback of joint portion) together with a file name of content corresponding to an edit point and edit start/end point via the controller 102. Whereupon the splice edit section 101 reads a data equivalent to a predetermine time (e.g., 3 seconds, changeable by setup) before and after the edit point from the corresponding video content, and then, edits it partially. Subsequently, a splice playback section 103 plays back the partially edited video data, and thereafter, displays it on a splice view 108.

Unnecessary edit segment is deleted by splice playback confirmation, and an edit segment requiring a change is finely adjusted. Finally, all edit segments and all joint portions are confirmed in their consistency, and thereafter, an edit start command input section 107 outputs an edit start command, and thereby, the video content is edited.

Next, the following is a description on frame unit edit of MPEG content in a frame unit edit section 100. As shown in FIG. 30, the edit processing is made as compressed data is unchanged except that a base band edit section 109 partially decodes the edit point former half 110 and the edit point latter half 111, and carries out edit and re-compression. Therefore, it is possible to prevent degradation of picture quality, to reduce a temporary saving disk for avoiding the entire decoding, and to achieve high speed processing.

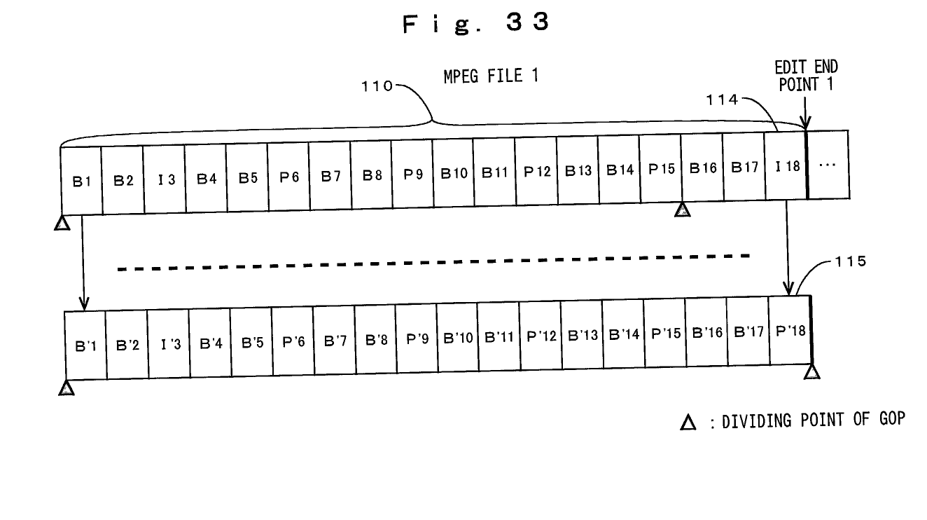

A frame unit editing method on MPEG compressed data will be detailedly described below with reference to FIG. 31 to FIG. 38. In these figures, the frame display array is all display order. The difference between display order and stream order is as shown in FIG. 31; more specifically, frame array on MPEG-compressed stream is stream order, and frame array after being decoded and played-back is display order.

FIG. 32 shows the case where the edit point former half is cut after a P frame 112, and the edit point latter half is cut just before a P frame 113. In the edit point former half portion, a bit distribution of all frames (equivalent to 110) before the P frame 112 in the same GOP including the P frame 112 is changed. On the other hand, in the edit point latter half portion, a bit distribution of all frames after the P frame in the same GOP including the P frame 113 and the head two B frames (equivalent to 111) belonging to the next GOP is changed. In this case, picture type has no change; however, the amount of bit distribution to each frame, that is, quantizer scale is adjusted so that a VBV (Video Buffering Verifier) is not destroyed at the head of stream. Each processing of the edit point former half and the edit point latter half will be detailedly described below.

First, the following is a detailed description on the processing of the edit point former half. FIG. 33 shows the case where the edit point former half is cut after an I frame 114. In the edit point, the GOP is closed; for this reason, a picture type of the I frame 114 is changed into a P frame 115, and bit distribution is changed in a state that the picture type of all frames belonging to the GOP before one is unchanged as it is. In the case of changing the I frame into the P frame, the I frame is once decoded, and thereafter, is re-coded as P frame. However, in this case, the P frame usually has a bit amount of a few of the I frame; for this reason, the bit amount generated by that the I frame is changed to P frame is redistributed to the remaining frame of GOP.

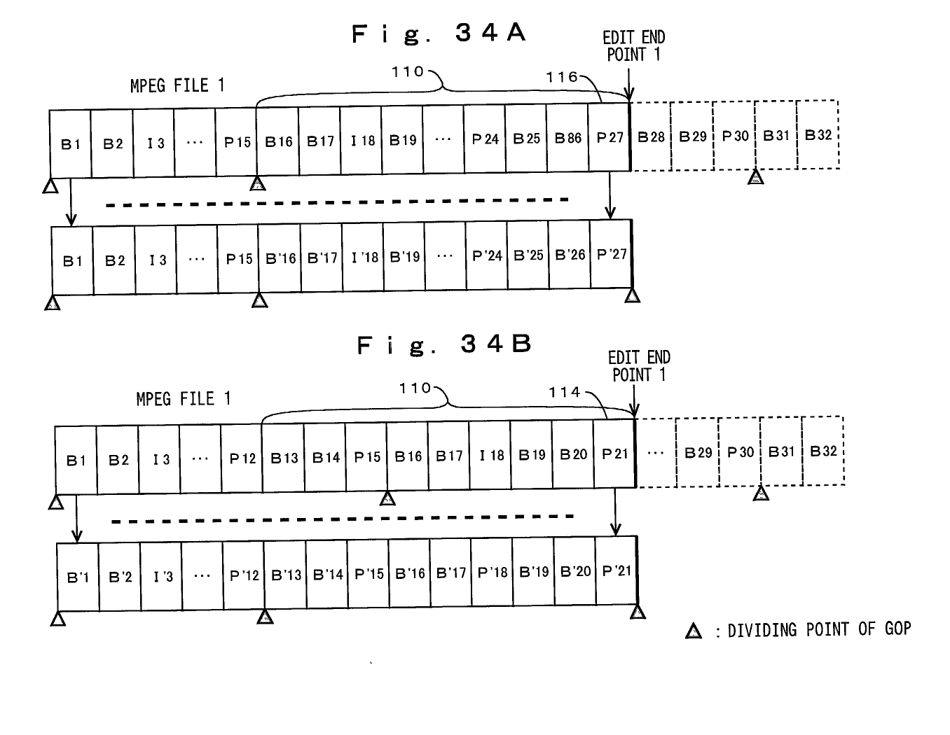

FIG. 34A shows the case where the edit point former half is cut after a P frame 116. A picture type of the P frame 116 is unchanged, and the bit amount of all frames (equivalent to 110) before the P frame 116 in the same GOP including the P frame 116 is redistributed. In this case, B frames B28 and B29 having a bit amount considerably less than the P frame are deleted; therefore, the bit amount is less redistributed so that the P frame connects with the I frame of the next GOP, and buffer underflow is not generated.

However, in FIG. 34B showing the case where the edit point former half is cut after the same P frame, the edit point is positioned at the former half of GOP, and bit distributing operation is difficult in the same GOP; for this reason, the bit redistribution is carried out including the GOP before one. In this case, I16 is changed to P′16 in its picture type, and thereby, the GOP structure having 15-frame configuration can be changed to a GOP structure having 21-frame configuration.

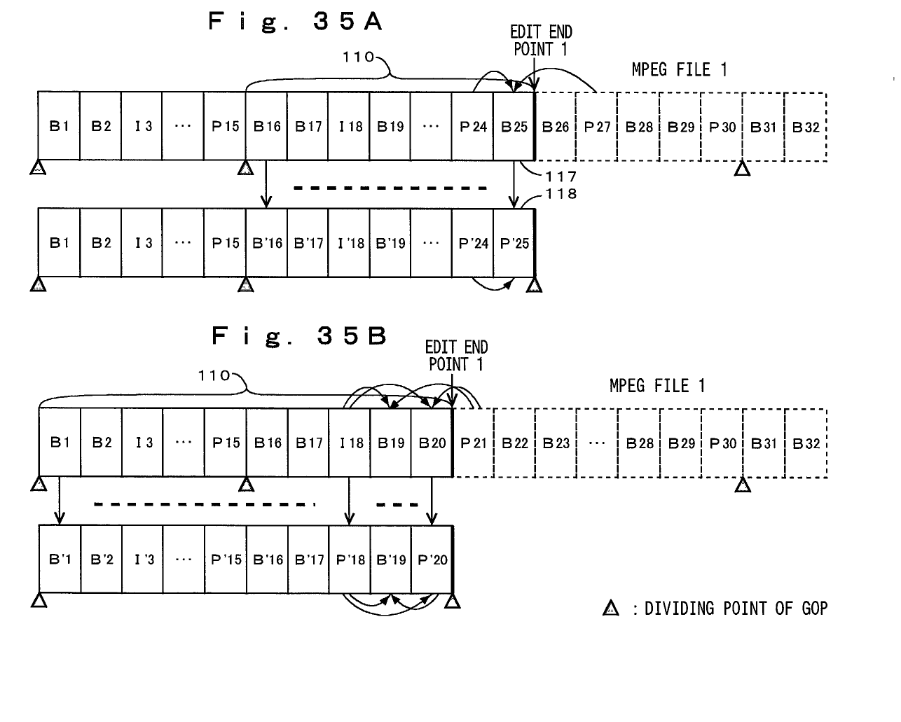

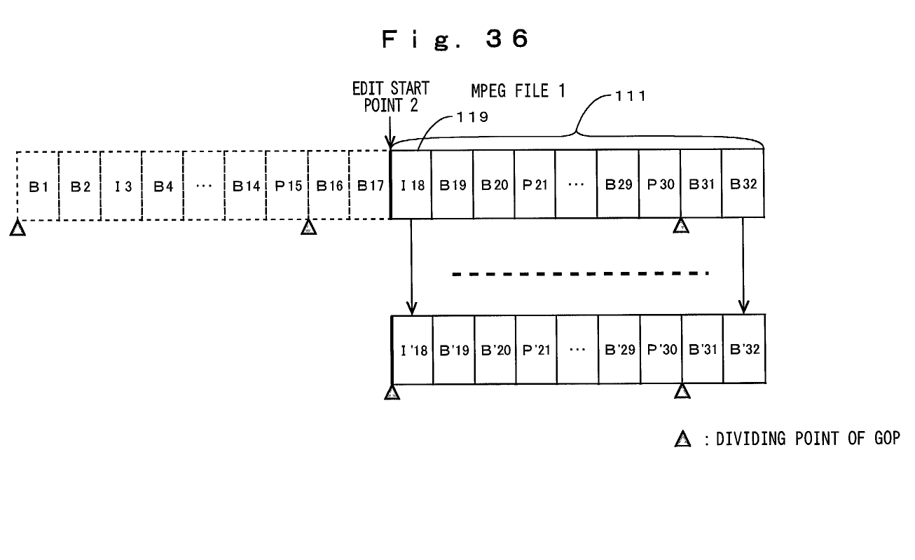

FIG. 35A shows the case where the edit point former half is cut after a B frame 117. The B frame 117 is changed to a P frame in its picture type, and the bit amount of all frames (equivalent to 110) before the B frame 117 of the same GOP including the B frame 117 is redistributed. In the case of changing the B frame to the P frame in its picture type, basically, the B frame is once decoded, and then, is re-encoded as P frame. In macro block carrying out motion compensation of only forward direction in the B frame, even if the B frame is changed to the P frame, the same direction motion compensation is carried out. For this reason, a motion vector is intactly used, and then, re-encoding is carried out, and thereby, it is possible to improve a processing speed as compared with the case of newly carrying out motion search processing with respect to the entire MB.

In FIG. 35B showing the case where the edit point former half is cut after the same B frame, the edit point is positioned at the former half of GOP, and the bit distributing operation is difficult in the same GOP; for this reason, bit redistribution is carried out including the GOP before one. In this case, I18 is changed to P′18 in its picture type, and thereby, the GOP structure having 15-frame configuration can be changed to a GOP structure having 20-frame configuration. In the case of making a change from B19 to B′19, the bit distribution is changed, and in addition, a reference frame used in backward motion compensation is changed from P21 to P′20. For this reason, in MB using bi-directional motion compensation or backward motion compensation, a motion vector must be again searched.

The processing of the edit point former half has been described above. Next, the processing of the edit point latter half will be detailedly described below. FIG. 36 shows the case where the edit point latter half is cut after an I frame 119. A bit distribution change of all frames after the I frame 119 of GOP including the I frame 119 and the head B frames B31 and B32 (equivalent to 111) belonging to the next GOP is carried out.

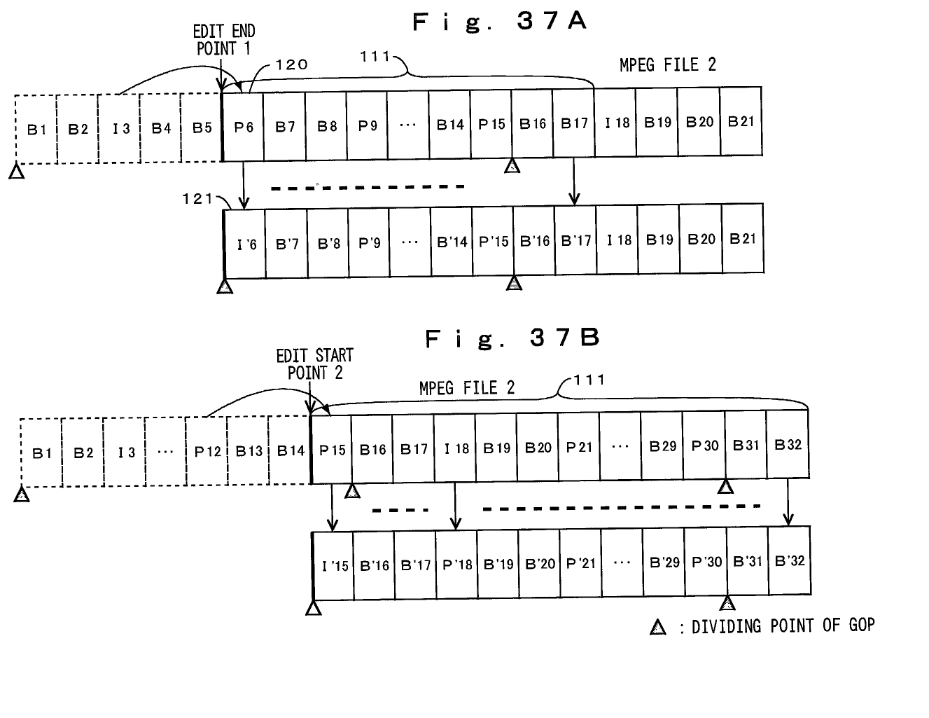

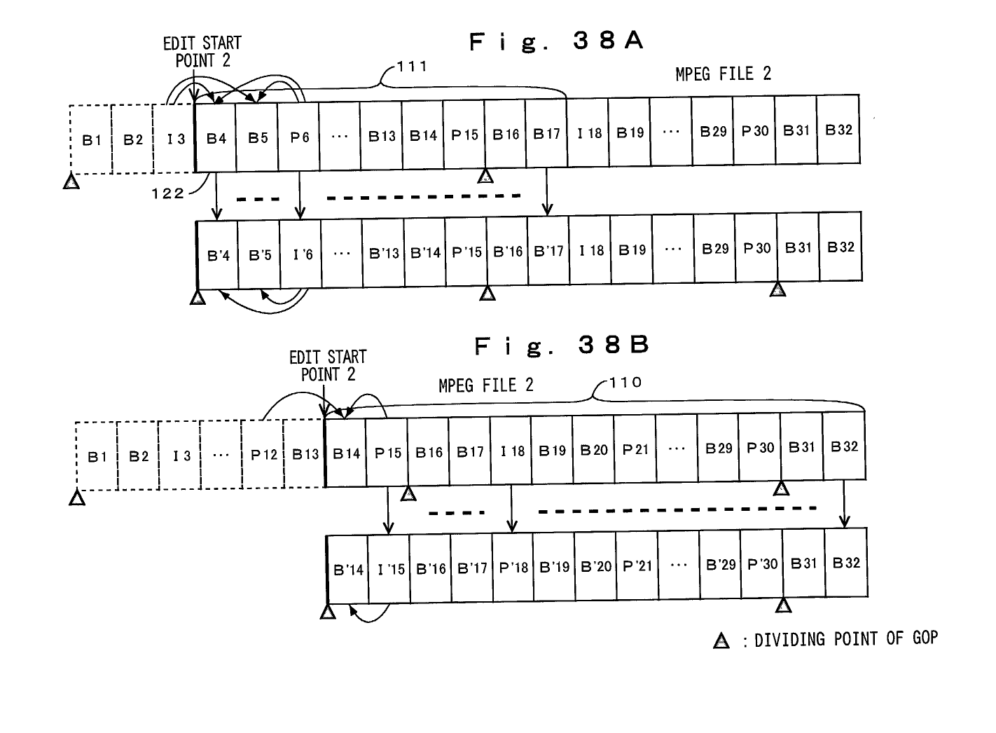

FIG. 37A shows the case where the edit point latter half is cut just before a P frame 120. Since a new GOP starts at the edit point, the P frame 120 is changed to an I frame 121 in its picture type, and a bit distribution of all frames after the P frame 120 included in the same GOP and the head B frames B16 and B17 (equivalent to 111) belonging to the next GOP is carried out. In the case of changing the P frame to the I frame, the P frame is once decoded, and then, is re-encoded as I frame. In this case, the I frame usually has a bit amount of several times as much as the P frame. For this reason, in the remaining frame of the GOP, the bit amount generated by that the P frame is changed to the I frame is redistributed so that the increased bit amount can be absorbed. However, in FIG. 37B showing the case where the edit point latter half is cut just before the same P frame, the edit point is positioned at the latter half of GOP, and the bit distributing operation is difficult in the same GOP. For this reason, the bit redistribution is carried out including the head two B frames belonging to the next GOP and another next GOP. In this case, P15 is changed to I′15 in its picture type, and thereby, the GOP structure having 15-frame configuration can be changed to a GOP structure having 16-frame configuration.

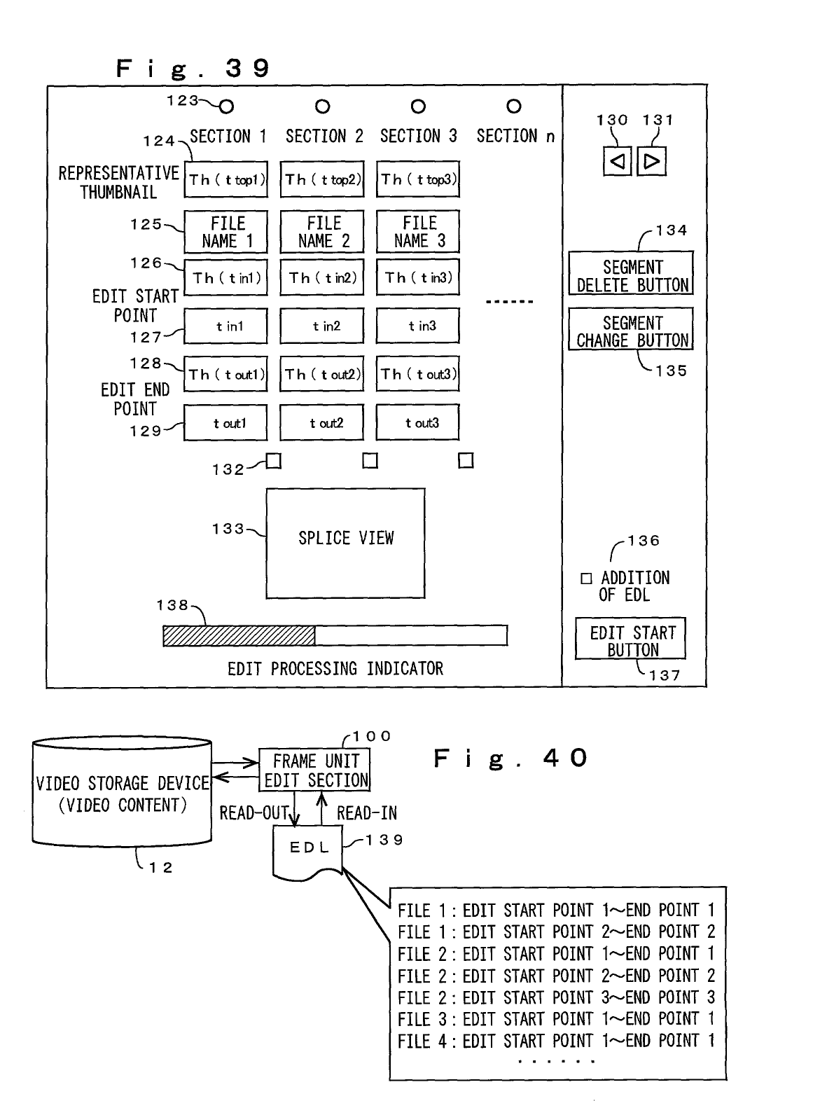

FIG. 38A shows the case where the edit point latter half is cut just before a B frame 122. Since a new GOP starts at the edit point, the I frame is required in the vicinity of the head position; for this reason, the frame P6 is changed the frame I′6 in its picture type. Consideration is made such that the B frame 122 is changed to I frame in its picture type; however, Conversion from B frame to I frame is not suitable because the I frame has a large bit amount, and is used as reference image requiring a picture quality. In other frames, a bit mount of all frames after the B frame 122 of the same GOP including the B frame 122 and the head B frames B16 and B17 (equivalent to 111) belonging to the next GOP is redistributed. In conversion from B4 to B′4 and from B5 to B′5, the bit amount is adjusted, and in addition, there is no reference I3 frame for forward motion compensation; for this reason, in MB using bi-directional or forward motion compensation, the motion vector must be again searched.

In FIG. 38B showing the case where the edit point former half is cut just before the same B frame, the edit point is positioned at the later half of GOP, and the bit distributing operation is difficult in the same GOP. For this reason, bit redistribution is carried out including the head two B frames (equivalent to 111) of the next GOP and further next GOP. In this case, I18 is changed to P′18 in its picture type, and thereby, the GOP structure having 15-frame configuration can be changed to a GOP structure having 17-frame configuration. In the case of making a change from B14 to B′14, the bit distribution is changed, and in addition, there is no reference frame P12 used for forward motion compensation; for this reason, in MB using bi-directional motion compensation or forward motion compensation, a motion vector must be again searched.

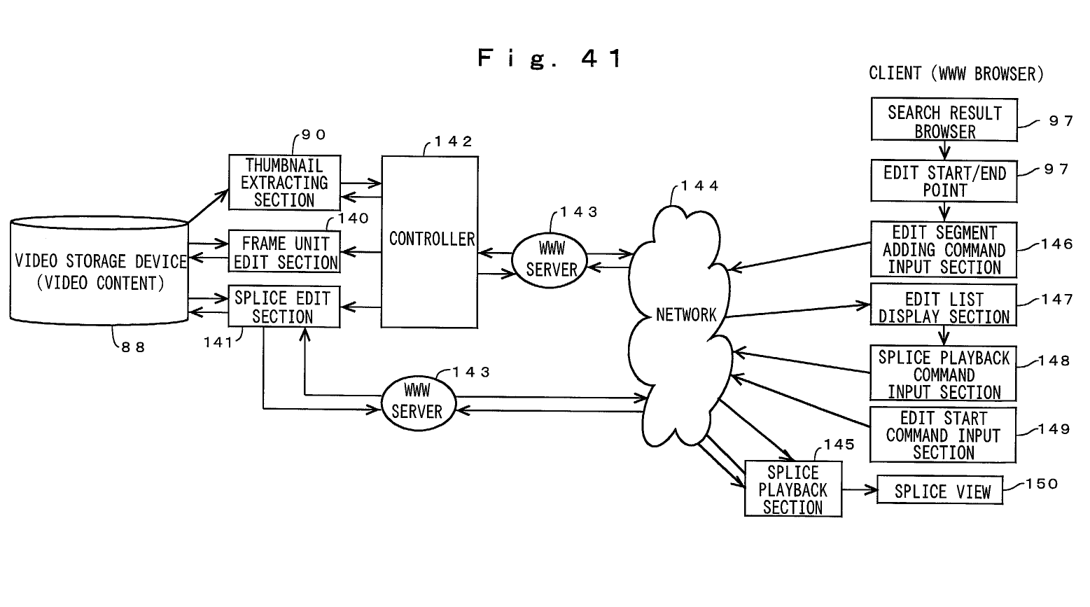

Next, the following is an example of a description on a screen used in carrying out frame unit edit using video thumbnail retrieval and browsing result. The screen is a video index browser and video player complexly using the cut point retrieval browser, the telop retrieval browser, the audio classification browser and the frame unit browser described in FIG. 27. First, in the video index browser and video player, when pushing an edit segment adding button 86 using of playback start time/playback end time of the designated and confirmed segment playback as edit start/end point, the edit start/end point is added as edit segment to a segment (e.g., segment 1) extracted by a segment extracting button 123 of edit control screen (see FIG. 39).

In a representative thumbnail display area 124, a thumbnail Th(t top1) of the time t top1 (t top1=0: the top of content) representative of inserted video content is displayed. In a file name display area 125, the file name of the content is displayed. Edit start point thumbnail Th(t in1), edit start point time code (t in1), edit end point thumbnail Th(t out1) and edit end point time code (t out1) are displayed in an edit start point thumbnail display area 126, an edit start point time code display area 127, an edit end point thumbnail display area 128 and an edit end point time code display area 129, respectively. By repeating the same operation as described above, edit segment is added by the segment n.

In the case where the edit segment list is not displayed at one time, a left skip button 130 and a right skip button 131 are pushed, and thereby, the next edit segment is displayed. Further, In the case of deleting an edit segment, a segment delete button 134 is pushed in a state of extracting the segment to be deleted. Further, in the case of finely adjusting the edit start/endpoints of the segment, a segment change button 135 is pushed in a state of extracting the segment, and thereby, the thumbnail and time code of the corresponding edit segment is displayed at the playback start time point/playback end time point as shown in FIG. 27 to be finely adjusted it again.

In FIG. 39, all edit segments are inserted, and thereafter, in the case of confirming visual consistence of the edit point before carrying out edit operation, the following operation is made. More specifically, when pushing a splice view display button 132 of the edit point to be confirmed, and thereby, the joint portion is partially edited from the data before and after the edit point for a short time, and is video-displayed on a splice view 133. After confirming the consistence of the joint portion of the edit point by the splice view, correction is made in succession if delete and change of the edit segment is necessary. Finally, at the point of time when all edit segments are confirmed, an edit start button 137 is pushed in order to start an edit work. The progress of edit processing is displayed by an edit processing indicator 138.

In edit starting, when a check is made to an EDL addition button 136, as shown in FIG. 40, the edit segment list is outputted as an EDL (Edit Decision List) file 139 conformable to SMPTE (Society of Motion Picture & Television Engineer) together with video edition. Further, the EDL file is read from the outside, and thereby, it is possible to replay past edit operation, and to fetch and edit the edit list prepared using VTR from the outside. This process is effective as the method of doing an edit work using only edit list without exchanging a large capacity video content in carrying out edit work between remote places.

Next, the following is a description on a ninth embodiment of the present invention. According to this ninth embodiment, frame unit edit using the video thumbnail retrieval and browsing result described in the above eighth embodiment is applied to server client configuration on network.

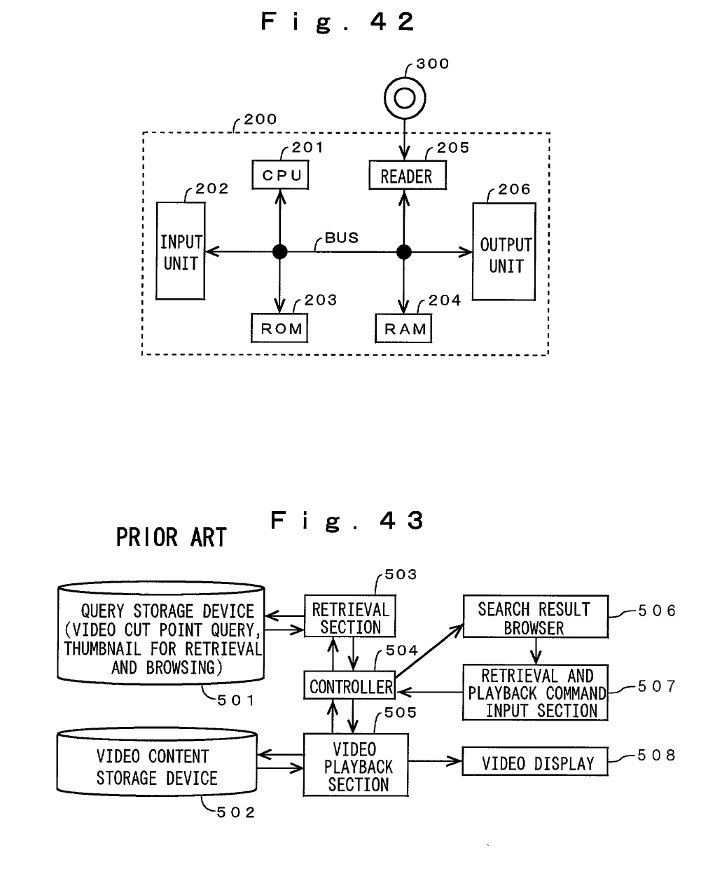

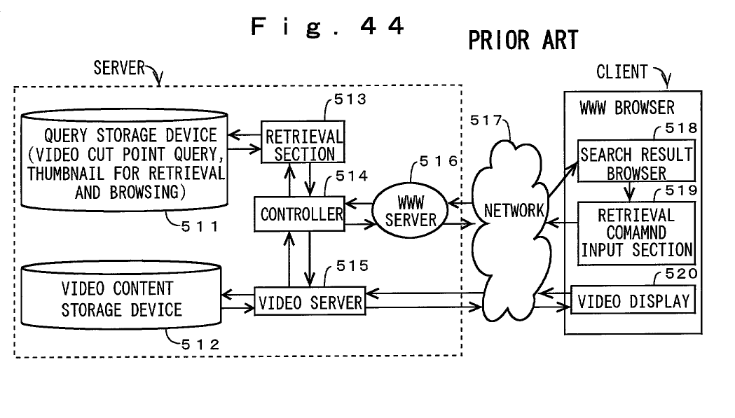

In FIG. 41, each operation of the thumbnail extracting section 90, the search result browser 97 and the video storage device 88 is the same as that of FIG. 28. In the search result browser 97, frame precision edit start/end points are found from the retrieval results such as browsed thumbnail, cut point retrieval, telop retrieval, audio classification and frame unit retrieval. Then, the time code and file name is inputted to a controller 142 from an edit segment adding command input section 146 via a network 144 and a WWW server 143.

The controller 142 extracts a thumbnail having edit start/end points and content head time code from the thumbnail extracting section 90 together with the added edit segment time code, and then, additionally displays it on an edit list display section 147 via the WWW server 143 and the network 144. The edit segment adding operation is repeated, and thereafter, in order to check visual consistence of video playback of each edit point (each joint portion), the video playback is confirmed by splice edit (partial edit of joint portion) and splice playback (partial playback of joint portion) via the network.

The splice edit/playback processing via network will be described below. First, a splice playback command input section 148 inputs a splice playback (partial playback of joint portion) command together with the file name and edit start/end points of the content corresponding to the edit point by a splice edit section 141 via the network 144, the WWW server 143 and the controller 142. Whereupon the splice edit section 141 reads data having a predetermined time (e.g., 3 seconds, changeable by setup) before and after the edit point from the corresponding video content, and thereafter, partially edits it. Subsequently, the partially edited video data is transmitted to a splice playback section 145 via the WWW server 143, and thereafter, is played back and displayed on a splice view 150.

Unnecessary edit segments are deleted by splice playback confirmation; on the other hand, edit segments requiring a change are finely adjusted. The consistence of all edit segments and all joint portions is finally confirmed, and thereafter, the edit start command input section 149 outputs an edit start command to the controller 142 via the network 144 and the WWW server 143, and thereby, the frame unit edit section 140 executes edit processing of video content.

By doing so, it is possible to effectively retrieve, browse and edit the video image and to make a confirmation before edit by splice view from remote places via the network. Further, the edited video can be confirmed and played back in the retrieval, browsing and playback system on the network described in the above seventh embodiment.

The eighth and ninth embodiments of the present invention have been described above with reference to the accompanying drawings. The detailed configuration is not limited to these eighth and ninth embodiments, and the present invention may include various changes in design within the scope of the present invention without diverging from the gist thereof.

For example, in the eighth and ninth embodiments of the present invention, the following manner may be carried out. More specifically, the thumbnail extracting program of the thumbnail extracting sections 14 and 90, the frame unit edit program of the frame unit edit sections 100 and 140, and the splice edit program of the splice edit sections 101 and 141 are recorded in the computer readable recording medium 300 shown in FIG. 42. Then, the computer 200 shown in FIG. 42 reads these thumbnail extracting program, frame unit edit program and splice edit program recorded in the recording medium 300, and thereafter, may execute these programs. In this case, these thumbnail extracting program, frame unit edit program and splice edit program are programs for realizing each function of the thumbnail extracting section, the frame unit edit section and the splice edit section, which are shown in FIG. 29 and FIG. 41.

In the computer 200 shown in FIG. 42, the CPU 201 reads the thumbnail extracting program recorded in the recording medium 300 via the reader 205, and thereafter, executes these thumbnail extracting program, frame unit edit program and splice edit program. By doing so the above-mentioned thumbnail extracting processing, frame unit edit processing and splice edit processing are carried out. The recording medium 300 includes portable recording medium such as optical disk, floppy disk, hard disk, and in addition, includes transmission medium such as network, which temporarily records and holds data.

As is evident from the above description, in the video retrieval, browsing and editing apparatus of the present invention, the following effects can be obtained.

(1) It is possible to effectively and accurately designate the edit start/end points using the cut point retrieval, the telop retrieval, the audio classification and the frame unit retrieval, and thereby, to achieve video frame unit edit.

(2) In the case of carrying out the frame unit edit processing of MPEG content, the edit processing is carried out in a state of unchanging compressed data except that only partial data before and after the edit point is decoded to base band, and then, is re-compressed. Therefore, it is possible to prevent degradation of picture quality, to reduce a temporary saving disk by non-execution of the entire decoding, and to realize high-speed processing.

(3) The confirmation by splice edit (partial edit of joint portion) and splice playback (partial playback of joint portion) is carried out, and thereby, it is possible to check visual consistence of video playback of each edit point (joint portion) before carrying out video frame unit edit.

(4) In editing the video, the edit segment list is outputted as EDL file conformable to SMPTE (Society of Motion Picture & Television Engineers), and is read out of the outside. By doing so, it is possible to do a new edit work based on the past edit operation, and to fetch and edit the edit list prepared using the VTR from the outside. Further, in the case where edit work is done at remote place, it is possible to instruct the edit work using only edit list from the remote place without making the exchange of video contents.

(5) It is possible to carry out the processings described in the above items (1) to (4) on the network in a state of having the video data in common, in addition to the local host computer.

(6) It is possible to provide a computer readable recording medium recording the program capable of preventing degradation of picture quality by non-execution of the entire decoding of MPEG content, reducing a temporary saving disk, and realizing high-speed processing.

(7) It is possible to provide a computer readable recording medium recording the program capable of executing frame unit edit and splice edit.

What is claimed is:

1. A video retrieval and browsing apparatus for retrieving and browsing a digital video content such as MPEG, comprising:
time direction retrieval means for carrying out time direction retrieval of video content;
thumbnail extracting means for extracting a thumbnail from the video content in real time based on the retrieval result of the time direction retrieval means; and
search result browser for browse-displaying the retrieval result using the thumbnail extracted by the thumbnail extracting means.

2. The video retrieval and browsing apparatus according to claim 1, wherein the time direction retrieval means carries out retrieval in a state of designating a retrieval start point on time axis using a video cut point query.

3. The video retrieval and browsing apparatus according to claim 2, wherein the search result browser displays a cut point thumbnail sequence having a predetermined number and a cut point time line sequence corresponding to the thumbnail.

4. The video retrieval and browsing apparatus according to claim 1, wherein the time direction retrieval means carries out retrieval in a state of designating a retrieval start point on time axis using a video telop query.

5. The video retrieval and browsing apparatus according to claim 4, wherein the search result browser displays a telop start point thumbnail sequence having a predetermined number and a telop start point time line sequence corresponding to the thumbnail sequence.

6. The video retrieval and browsing apparatus according to claim 1, wherein the search result browser carries out retrieval in a state of designating a retrieval start point on time axis using a video audio classification data.

7. The video retrieval and browsing apparatus according to claim 6, wherein the search result browser displays an audio classification data sequence having a predetermined number, an audio classification point thumbnail sequence and an audio classification point time code sequence corresponding to the thumbnail.

8. The video retrieval and browsing apparatus according to claim 1, wherein the time direction retrieval means designates a retrieval start point on time axis of the video, and carries out retrieval at predetermined intervals such as frame unit and second unit.

9. The video retrieval and browsing apparatus according to claim 2, further including means for carrying out retrieval at further fine time interval using a time position designated on a screen of the search result browser as a new retrieval start point.

10. The video retrieval and browsing apparatus according to claim 9, wherein the search result browser displays a frame unit thumbnail sequence having a predetermined number and a frame unit time line sequence corresponding to the thumbnail sequence.

11. The video retrieval and browsing apparatus according to claim 1, further including a thumbnail cache memory for storing the thumbnail extracted by the thumbnail extracting means,
the same thumbnail being read from the thumbnail cache memory so as to reduce a process of extracting the same thumbnail.

12. The video retrieval and browsing apparatus according to claim 11, wherein when extracting a retrieval result browsing thumbnail from MPEG compressed contents, a GOP (Group of Pictures) including a frame equivalent to the thumbnail to be extracted is fully decoded and saved in the thumbnail cache memory, and thereby, decoding of another frame included in the same GOP is omitted.

13. The video retrieval and browsing apparatus according to claim 1, wherein the video content is stored in a WWW server, and the time direction retrieval means and the thumbnail extracting means is provided in the WWW server.

14. The video retrieval and browsing apparatus according to claim 13, wherein a WWW browser is connected to the WWW server via a network so that the WWW server can carry out video retrieval processing, and the WWW browser can designate retrieval conditions and browse-display the retrieval result.

15. The video retrieval and browsing apparatus according to claim 13, wherein in the case of carrying out segment playback of video content, a bit rate of the video content is converted and outputted in accordance with a network bandwidth when an output network band is narrower than a transmission bit rate of video content such as internet.

16. A computer readable recording medium recording a thumbnail extracting processing program for extracting a thumbnail from a video content in real time based on the given time code sequence.

17. The computer readable recording medium according to claim 16, wherein the thumbnail extracting program includes a process for decoding video based on the given time code sequence, and a process for generating a thumbnail from the decoded video.

18. A video retrieval, browsing and editing apparatus for editing a digital video content such as MPEG, comprising means for designating an edit start point and an edit end point using thumbnail retrieval and browsing result complexly using cut point retrieval, telop retrieval or audio classification and frame unit retrieval.

19. The video retrieval, browsing and editing apparatus according to claim 18, further including means for decoding only partial data before and after the edit point to base band, and editing and re-compressing it in the case of carrying out the frame unit edit processing of MPEG content in a state that the data other than the partial data before and after the edit point is intactly compressed data.

20. The video retrieval, browsing and editing apparatus according to claim 18, further including means for making a confirmation by splice edit (partial edit of joint portion) and splice playback (partial playback of joint portion) in order to check visual consistence of video playback of each edit point (joint portion) before carrying out video frame unit edit.

21. The video retrieval, browsing and editing apparatus according to claim 18, further including:
means for outputting the edit segment list as an EDL (Edit Decision List) file conformable to SMPTE (Society of Motion Picture & Television Engineers) in editing video; and
means for reading the EDL from the outside and taking over the editing operation.

22. The video retrieval, browsing and editing apparatus according to claim 18, wherein all processings are carried out using WEB via network.

23. A computer readable recording medium recording a program for decoding only partial data before and after the edit point designated using the thumbnail retrieval and browsing result to base band, editing it at the edit point, and re-compressing the decoded data in the case of carrying out the frame unit edit processing of MPEG content.

24. A computer readable recording medium recording a splice edit and playback processing program for confirming a visual consistence of joint portion in each edit point before carrying out the edit processing.

25. A computer readable recording medium recording a processing program capable of inputting and outputting an edit segment list as an EDL (Edit Decision List) file conformable to SMPTE (Society of Motion Picture & Television Engineers) in editing video.
